(19) United States
(12) Patent Application Publication
(10) Pub. No.: US 2025/0200945 A1
(43) Pub. Date: Jun. 19, 2025

(54) MULTIMODAL CONTENT RELEVANCE PREDICTION USING NEURAL NETWORKS

(71) Applicant: Microsoft Technology Licensing, LLC, Redmond, WA (US)

(72) Inventors: Neil Miten Daftary, Sunnyvale, CA (US); Yanping Chen, Cupertino, CA (US); Zhoutong Fu, Milpitas, CA (US); Shihai He, Sunnyvale, CA (US); Di Wen, Sunnyvale, CA (US)

(21) Appl. No.: 18/544,187

(22) Filed: Dec. 18, 2023

(51) Int. Cl. G06V 10/77; G06F 16/2457; G06F 16/28; G06F 40/284

(52) U.S. Cl. CPC G06V 10/7715; G06F 16/24578; G06F 16/285; G06F 40/284

(57) ABSTRACT

Computer-implemented techniques for multimodal content relevance prediction using neural networks involves processing multimodal content comprising a digital image and text. Initially, dense embeddings are obtained: an image embedding from a pretrained convolutional neural network, and a text embedding from a pretrained transformer network. These embeddings encapsulate the features of the image and text respectively. Two pretrained dense neural sub-networks then reduce the dimensionality of these embeddings. A third dense neural sub-network determines a numerical score for the multimodal content using the reduced embeddings and an additional feature embedding. This score reflects various aspects of the multimodal content, leading to an action taken based on this numerical evaluation, providing a comprehensive and nuanced understanding and management of multimodal digital content.

### BACKGROUND

Artificial neural networks (or just “neural networks”) are useful for predicting content relevance. Neural networks can model complex non-linear interactions between features and can automatically learn and understand intricate relationships and interactions between various features. Neural networks can process and learn from multimodal data, such as text and images.

### BRIEF DESCRIPTION OF THE DRAWINGS

The following detailed description of certain embodiments of the invention may be understood by reference to the following figures:

FIG. 1 illustrates an example system and method for multimodal content relevance prediction using neural networks.

FIG. 2 illustrates an example of multimodal content in the form of a social media advertisement post.

FIG. 3 illustrates an example natural language processing neural network pipeline.

FIG. 4 illustrates an example convolutional neural network pipeline.

FIG. 5 illustrates an example dense neural sub-network for dimensionality reduction of a contextual text embedding.

FIG. 6 illustrates an example dense neural sub-network for dimensionality reduction of a dense image embedding.

FIG. 7 illustrates an example of training the model pipeline of FIG. 1.

FIG. 8 illustrates an example variation of the model pipeline of FIG. 1.

FIG. 9 illustrates an example of a programmable electronic device that processes and manipulates data to perform tasks and calculations disclosed herein for multimodal content relevance prediction using neural networks.

### DETAILED DESCRIPTION

Systems, methods, and non-transitory computer-readable media (generally, “techniques”) are disclosed for multimodal content relevance prediction using neural networks.

### GENERAL OVERVIEW

Using a neural network to predict the relevance of multimodal content is a multifaceted challenge. Some of the challenges include ensuring that features from different modalities are compatible and meaningfully contribute to predictions. Another non-trivial challenge is crafting a neural network architecture that effectively leverages all types of features. The architecture should be effectively designed to handle the various data types, ensuring that each modality's information is effectively captured. Another challenge is managing high-dimensional data, especially when dealing with rich text and image features, to avoid the curse of dimensionality. Also, it is also desirable to ensure that the neural network, despite its complexity, makes quick low latency predictions in real-time scenarios and operates at scale, handling large volumes of multimodal content efficiently.

While predicting the relevance of multimodal content using neural networks can be a powerful approach, it comes with intricate challenges in network design. Strategies are needed to effectively integrate diverse features and to ensure network robustness.

The accuracy of a neural network prediction as to the relevance of multimodal content can be vitally important to the success of an action taken involving the content based on the prediction. Unfortunately, there is no single neural network architecture that ensures accurate predictions. So, careful network design is needed. Along with the need for prediction accuracy, there is a need in online and nearline contexts for network efficiency (e.g., low latency and high throughput) in determining the predictions.

The techniques disclosed herein balance the need for accuracy with the need for efficiency, using a neural network architecture that uses separate dense sub-networks to reduce the dimensionality of input dense image embeddings and input contextual text embeddings, respectively, along with late fusion of the reduced dimensionality image and text embeddings with additional embeddings representing other features pertaining to the predictions. The fused embeddings are then input to a third dense sub-network that is used to determine the predictions.

As an example of a problem addressed by the techniques disclosed herein, consider an online social media platform that presents to users personalized and continually updating lists or streams of content that users can interact with. Such a list or stream of content is commonly referred to as a “feed.” The online social media platform may select content (e.g., advertisements) to present to users in their feeds. Such content can be of varying interest to different users and be multimodal comprising both text and imagery. It is very difficult for the social media platform to accurately predict which content will be most relevant to users without the help of machine learning models that capture the underlying patterns of affinities between users and the content they are most likely to interact with. Thus, the social media platform may invest ample time and resources in developing and maintaining neural networks that are designed to accurately predict whether a given user will be interested in (e.g., click-on or otherwise interact with) given content if the content is presented in the user's feed.

As such, well-designed neural networks are both accurate and efficient in determining predictions. Efficient neural networks improve social media platforms, which may consume fewer compute resources (e.g., CPU, memory, and power). Accurate neural networks also provide improvements. If less relevant content is presented in a user's social media feed, the user may spend less time on the platform, or the platform may receive less user engagement. There may be more relevant content to present to the user.

The techniques herein provide for more accurate relevance predictions for multimodal content as well as efficiency in determining those predictions. Further, the techniques apply to more than just neural networks for predicting the relevance of multimodal content to users. They can be used for any type of multimodal content scoring neural network, such as a quality control neural network model used to filter out low-quality content or spam; a trend analysis neural network model for identifying content that is becoming popular or trending; a forecasting neural network model for predicting which content might become popular or that will trend in the future; a content diversity neural network model for ensuring that users are exposed to a diverse range of content; a safety and moderation neural network model for identifying and filtering out content that violates community standards or is potentially harmful, inappropriate, or offensive; and the like. Content may be social media posts or other types of content items (e.g., documents or files) encompassing both text and imagery (e.g., images, graphics, or video).

The techniques herein use a neural network architecture that uses separate dense (e.g., fully connected) sub-networks to reduce the dimensionality of input dense image embeddings and input contextual text embeddings, respectively, along with late fusion of the reduced dimensionality image and text embeddings with additional embeddings representing other features pertaining to the content. The fused embeddings are then input to a third dense sub-network that determines the predictions.

Separate sub-networks for dimensionality reduction allows each sub-network to specialize and learn representations that are most useful for each type of data (text and image). Furthermore, separate dimensionality reduction sub-networks allow for fine-tuning or modification of each sub-network independently based on the specific needs and characteristics of each data type (text and image).

Late fusion allows each modality (text, image, and other features) to be processed by specialized neural network layers that are optimized for that type of data. Late fusion also helps preserve the unique characteristics of each modality (text, image, and other features), ensuring that important features are not diluted or lost when combined too early. Since each modality (text, image, and other features) are processed separately initially, sub-networks can be improved, replaced, or fine-tuned independently allowing for experimentation with changes to the architecture or processing of one modality without affecting the others. Since each modality is processed to a high-level individually, the fused representation can be richer and more comprehensive. Late fusion also allows for a fusion layer that can learn to adaptively weight different modalities based on their relevance and contribution to the task. Late fusion also allows the overall neural network model to exploit complex relationships and correlations between different modalities at a higher level of abstraction. In particular, combining representations at a later stage means that the fusion happens at a level where each modality's representation is already quite abstract and contextualized. Late fusion also facilitates handling discrepancies of misalignments between different modalities more gracefully, as each modality is allowed to “tell its own story” initially.

The techniques proceed by obtaining a dense image embedding encapsulating features of a digital image and a contextual text embedding encapsulating features of a text. A reduced dimensionality dense image embedding is generated by a first pretrained dense neural sub-network. A reduced dimensionality contextual text embedding is generated by a second pretrained dense neural sub-network. A numerical score of a content comprising or referencing the digital and the text is determined using all of: a third pretrained dense neural sub-network, the reduced dimensionality dense image embedding, the reduced dimensionality contextual text embedding, and one or more additional embedding represent features pertaining to determination of the numerical score. An action involving the content (e.g., selecting or excluding the content for presentation in a user's social media feed) is then taken based on the numerical score.

The techniques herein may rely on a convolutional neural network (CNN) pipeline to generate the dense image embedding encapsulating features of the digital image and a natural language processing (NLP) transformer neural network pipeline to generate the contextual text embedding encapsulating features of the text to ensure that sufficient features are extracted from the raw content and encapsulated in the embeddings before dimensionality reduction.

As used herein, the term “embedding” encompasses a learned continuous vector representation of data, like images, text, or other features, which transforms sparse, high-dimensional inputs into a dense, lower-dimensional form, capturing the intrinsic relationships and structures of the input data in the vector space.

As used herein, the term “neural network” encompasses a computational model inspired by the way biological brains work, consisting of interconnected nodes or “neurons” that process and transmit information, enabling the model to perform tasks such as classification, regression, and pattern recognition by learning from data.

A “deep neural network” is a type of neural network with multiple hidden layers between the input and output layers, which enables the learning of complex hierarchical features from the input data. Types of deep neural networks include dense neural networks, convolutional neural networks, and transformer neural networks.

A “dense neural network,” also known as a fully connected network, is a type of deep neural network wherein each neuron in a layer is connected to every neuron in the preceding and following layers, allowing for the comprehensive flow and processing of information through multiple interconnected nodes and layers.

A “convolutional neural network” or “CNN” encompasses a class of deep neural networks designed specifically for processing structured grid data, such as images, using convolutional layers to learn spatial hierarchies of features automatically and adaptively.

A “transformer neural network” encompasses an architecture primarily used in natural language processing tasks, characterized by attention mechanisms and layer-wise recurrence, enabling the parallel processing of sequential data, capturing dependencies, and interactions across varying distances in input sequences.

### Example System and Method for Multimodal Content Relevance Prediction Using Neural Networks

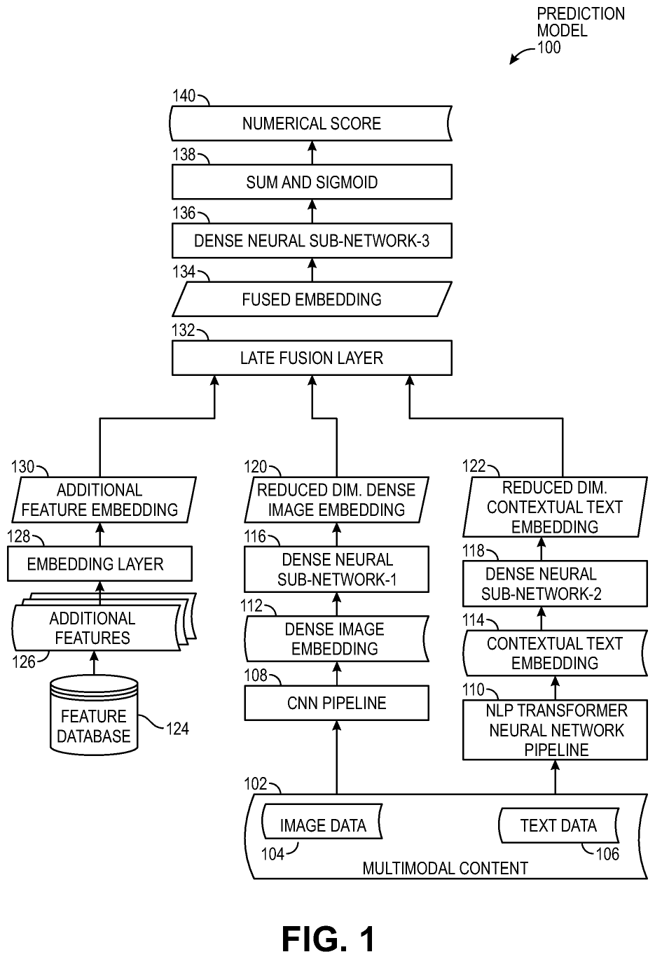

FIG. 1 illustrates an example system and method for multimodal content relevance prediction using neural networks. At a high-level, the example system operates according to the method by initially obtaining multimodal content 102 to be scored by prediction model 100. Multimodal content 102 includes image data 104 and text data 106. Image data 104 is input to convolutional neural network (CNN) pipeline 108 and text data 106 is input to natural language processing (NLP) transformer neural network pipeline 110 (“transformer pipeline 110”). CNN pipeline 108 outputs dense image embedding 112 by processing image data 104. Transformer pipeline 110 outputs contextual text embedding 114 by processing text data 106. Dense image embedding 112 is input to dense neural sub-network-1 116 and contextual text embedding 114 is input to dense neural sub-network-2 118. Dense neural sub-network-1 116 outputs reduced dimensionality dense image embedding 120 by processing dense image embedding 112. Dense neural sub-network-2 118 outputs reduced dimensionality contextual text embedding 122 by processing contextual text embedding 114.

Additional features 126 pertaining to the determination of numerical score 144 for content 102 obtained from additional feature database 124 are input to embedding layer 128. Embedding layer 128 determines additional feature embedding 130 by processing additional features 126. Late fusion layer 136 fuses combined additional feature embedding 130, reduced dimensionality dense image embedding 120, and reduced dimensionality contextual text embedding 122 to yield fused embedding 134. Fused embedding 134 is input to dense neural sub-network-3 136 and outputs of dense neural sub-network-3 136 determined by dense neural sub-network-3 136 processing fused embedding 134 are input to summation and sigmoid layer 138 which processes the outputs of dense neural sub-network-3 136 to determine numerical score 140.

As an example, consider the scoring of advertising content to determine whether the content should be presented in a user's social media feed. The score may reflect the probability that the user will click on or otherwise interact with the content if presented in the user's feed. Such a score may be referred to as a “click-through probability.” The content may be multimodal encompassing both text and imagery. The click-through probability model that determines the score may consider not just text and image features but also additional features pertaining to the score determination such as features of the user, features of the advertiser, and other features of the content. A challenge is how to combine effectively and efficiently all these different modality features in the model when determining the score.

Model 100 may be used to determine efficiently and accurately the click-through probability as numerical score 140. Model 100 employs separate dense sub-networks 116 and 118 for reducing the dimensionality of image and text embeddings, allowing each to specialize and adapt based on the data's unique characteristics. These processed embeddings are later fused with additional feature embeddings allowing each data modality (text, image, other features) to maintain its distinct characteristics and enabling independent fine-tuning of each modality. Late fusion facilitates the exploration of complex relationships between different modalities at a higher abstraction level, ensuring a richer, more adaptive, and comprehensive representation of the fused modalities.

As other examples, model 100 may be used to determine other types of numerical scores for content such any of the following types of numerical scores: a numerical score indicating whether the content is low-quality or spam; a numerical score indicating whether the content will trend or become popular in a future period; a numerical score indicating the content diversity of the content with respect to other content; a numerical score indicating whether the content violates community standards, is offensive, is inappropriate, or is harmful; or any other suitable type of numerical score for multimodal content that is determined based on text, image, and other features.

In some examples herein, content 102 is a social media post or the like comprising or referencing text and imagery. For example, content 102 can be an advertisement for which an advertiser has paid or will pay a social media platform to present in a user's social media feeds or otherwise to users of the platform. However, content 102 can be other types of content. For example, content 102 can be a document or file comprising or referencing text and imagery such as, for example, any of a webpage, an email, a page or other section of an e-book, a slide or other portion of a presentation document, a page or other section of a PDF document or other type of word processing document, educational content that combines text and imagery for learning, a page or other portion of a digital magazine or newspaper, an e-commerce product listing, or other suitable digital content comprising or referencing text or imagery.

Now for a more detailed discussion of the example system and method of FIG. 1. Content 102 is obtained for the purpose of scoring by model 100. Obtaining content 102 can involve various data collection and ingestion methods. For example, content 102 can be obtained via an application programming interface (API). Content 102 can be obtained by extracting content 102 from the hypertext markup language (HTML) of a webpage.

Content 102 can be obtained from accessing structured data directly from a database such as via a SQL or NoSQL database query. Content 102 can be obtained by downloading it from a website, data marketplace, or other data repository. Content 102 can be obtained as part of data gathering from sensors, smart devices, or smart phones. Content 102 can be obtained by downloading it from a cloud storage service via an API offered by the cloud storage service or directly via uniform resource locator (URL) that references content 102. Content 102 can be obtained by extracting it from an email. Content 102 can be obtained by consuming data in real-time from a streaming platform or service. Content 102 can be obtained by utilizing a pre-built code library that facilitates data acquisition or using a software development kit (SDK) in a mobile or web application to collect content 102 from a user.

Content 102 comprises or references image data 104 and text data 106. Content 102 may comprise data by containing the data within a container or data envelope representing content 102. For example, content 102 may be a file or JavaScript Object Notation (JSON)-formatted data that contains image data 104 or text data 106. Content 102 may reference image data 104 or text data 106 by containing a reference to data within the container or data envelope representing content 102. For example, content 102 may be a file or JSON-formatted data that contains a uniform resource locator (URL) or other identifier of a location or address at which the data can be accessed (e.g., downloaded).

Text data 106 encompasses data composed of strings of alphanumeric characters that is intended to be human-readable. Text data 106 may be unstructured and qualitative and may contain a natural language that represents various forms of information, communications, or intent. Examples of possible types of text data 104 include plaint text data that can be read and written by humans and computers; structured text data that follows a specific format or structure such as JSON or extensible markup language (XML); unstructured text data such as emails, social media posts, or e-books without a predefined structure or schema; semi-structured text data such comma-separated value (CSV) data or log file data that has some level of structure but is not as rigid as structured text; rich text data such as rich text format (RTF) or HTML content that includes formatting such as fonts, colors, or styles; or any other suitable text data type.

Image data 104 encompasses digital representations of visual information, captured or created, stored, and processed by computers. Image data 104 may encompass various formats and types, each suitable for different applications and uses. Image data 106 can be in various data formats such as a raster or bitmap image format (e.g., JPEG, PNG, GIF, BMP, etc.); a vector image format (e.g., SVG, etc.); or a raw image format. Image data 106 can reflect various color spaces such as RGB, CMYK, or grayscale. Image data 104 can, but need not be, captured by a digital camera. For example, image data 104 can be a natural image (e.g., a digital photo captured in a natural environment), a synthetic image (e.g., computer-generated image), a medical image (e.g., an image obtained from a medical imaging technology), a grayscale image (e.g., a black and white image with various shades of gray), a color image (e.g., a RGB image), or other suitable type of image.

### Example Multimodal Content

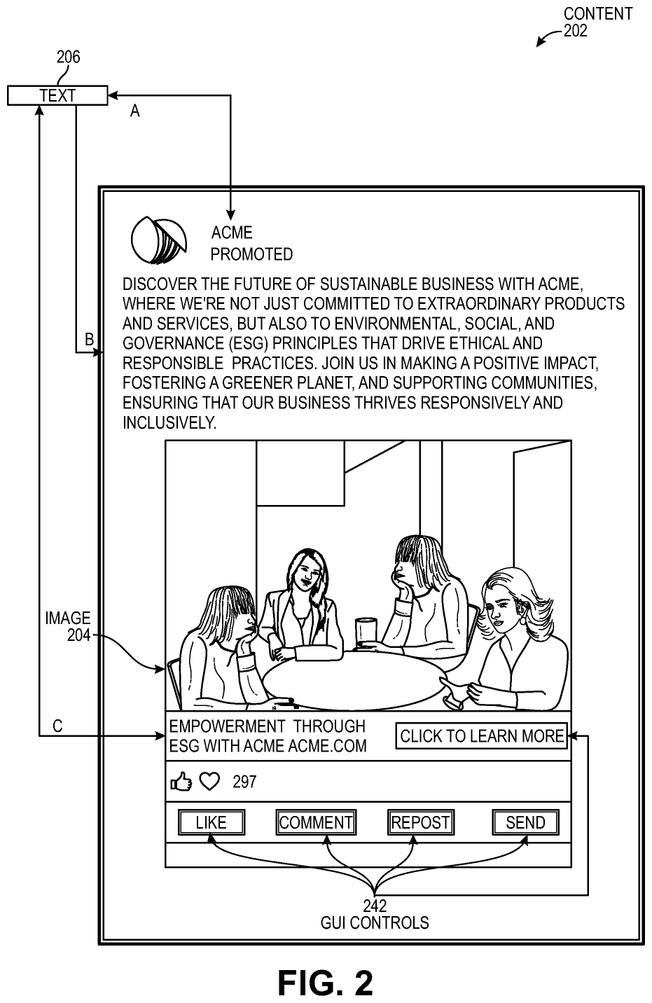

FIG. 2 illustrates an example of multimodal content in the form of a social media advertisement post. In the example of FIG. 2, content 202 (an example of content 102) includes text 206 (an example of text 206) and image 204 (an example of image 104). In the example of FIG. 2, model 100 may be used as a click-through prediction model to determine a numerical score (an example of numerical score 140) for content 202. In the example of FIG. 2, the numerical score represents how likely it is that a user will take a click-through action on content 202 if content 202 is presented to the user in the user's social media feed. In the example of FIG. 2, this numerical score is used to determine whether to present content 202 in the user's social media feed.

In this example of FIG. 2, text 206 includes A. the name of the advertising company “Acme”, B. the text description below the company name, and C. the text slogan below image 204. The social media post also includes various graphical user interface controls 242 for the user to perform a “click-through” action on the post including liking the post, commenting on the post, reposting the post on the user's own feed, sending the post to another user in the user's social media network, and navigating to a webpage that provides more information to the user about the subject matter of the post.

While image 106 of content 102 may be a static image like in the example of FIG. 2, image 106 of content 102 may be a portion of a video or animation. For example, image 106 may be a keyframe or I-frame of a digital video or a computer graphic animation.

### Example Natural Language Processing Transformer Neural Network Pipeline

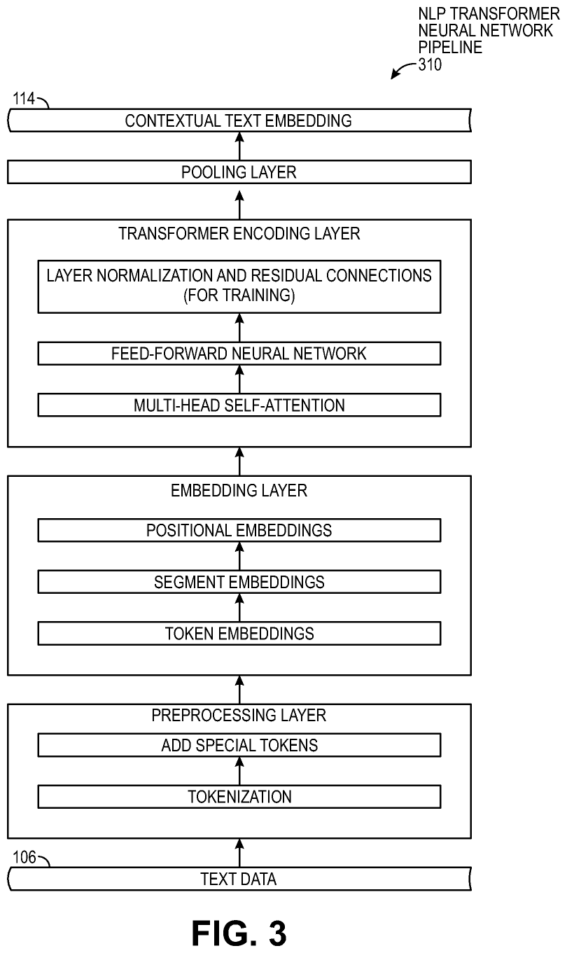

FIG. 3 illustrates an example natural language processing (NLP) transformer neural network pipeline for determining contextual text embedding 114 from text data 106. Contextual text embedding 114 generated by NLP transformer neural network pipeline 310 (equivalently “pipeline 310”) is a dense representation of text data 106 that encapsulates intricate semantic and contextual details of text data 106. Pipeline 310 has bidirectional capabilities that allows each word or token in text data 106 to be influenced by both its preceding and following words to create a rich, context-aware embedding 114. In some embodiments, pipeline 310 incorporates or is based on a Bidirectional Encoder Representations from Transformers (BERT) model or suitable variant thereof. Pipeline 310 is an example of a pipeline that may be used as pipeline 110 in model 100 of FIG. 1.

Returning to pipeline 310 of FIG. 3, at a high level, the process employed by pipeline 310 to determine contextual text embedding 114 from text data 106 includes, after preprocessing text data 106, the tokenized text data, including special tokens added, is passed through an embedding layer to obtain initial embeddings. These embeddings are passed through several transformer encoder layers where each token's embedding is updated based on the entire context of text data 106. After going through the transformer layers, a classification token embedding containing aggregated contextual information is taken as contextual text embedding 114. By focusing on the classification token, pipeline 310 generates a fixed-sized contextual representation that encapsulates the essential semantic information of the entirety of text data 106.

Pipeline 310 determines contextual text embedding 114 from text data 106 using several components and steps. Initially, in a preprocessing stage, text data 106 undergoes tokenization into words or subwords, and special tokens like the classification token (e.g., “[CLS]”) and a separator token (e.g., “[SEP]”) are incorporated for separation purposes. Following preprocessing, an embedding layer converts each token into high-dimensional vectors and integrates positional embeddings to encode the sequential position of each token within a segment or segments of text data 106. Segment embeddings may also be used depending on the length or characteristics of text data 106. Segment embeddings may also be used if text data 106 is treated by pipeline 310 as composed of multiple text segments (e.g., sentences). In a subsequent stage, transformer encoders, comprising multi-head self-attention mechanisms and feed-forward neural networks, operate to enable each word to dynamically interact with various parts of text data 106, thereby capturing a multitude of dependencies and relationships. Layer normalization and residual connections contribute to the stabilization of pipeline 310 during training of pipeline 310. In the pooling layer, the classification token, having traversed and been enriched through the previous layers of pipeline 310, emerges as a representative embedding of the entire text data 106, embodying the collective contextual information. Pipeline 310 may also include as an antecedent step to determining contextual text embedding 114 from text data 106 a fine-tuning stage where pipeline 310 is specialized or refined using relevant datasets for the general task of determining contextual text embeddings from input text data.

Preprocessing layer performs tokenization to prepare text data 106 for processing by the remainder of pipeline 310. Tokenization entails parsing text data 106 into manageable and interpretable units, referred to as tokens, which could be words or subwords. For example, tokenization may involve word tokenization, where text data 106 is divided at spaces and punctuation marks, creating distinct word tokens. Preprocessing layer may also perform subword tokenization on text data 106. Subword tokenization involves further breaking down words into smaller units or subwords. For example, preprocessing layer may use word piece tokenization to ensure that even out-of-vocabulary words (e.g., jargon, arcane terms, initializations, acronyms, etc.) are aptly represented in smaller recognizable segments. For example, if a word is not in the vocabulary, preprocessing layer may split the word into smaller pieces that are in the vocabulary. For example, the word “embeddings” might be split into “em”, “##bed”, “##ding”, “##s”.

Preprocessing layer integrates special tokens such as the classification token (e.g., “[CLS]”) and the separator tokens (e.g., “[SEP]”) to mark beginnings and endings in text data 106. Preprocessing layer ay strategically incorporates special tokens within text data 106 to bolster pipeline's 310 performance in determining contextual text embedding 114 and to enhance the contextual and structural discernment of pipeline 310.

One special token that is incorporated is the classification token (e.g., “[CLS]”). The classification token is incorporated at the beginning of text data 106 and serves as an aggregate representation of text data 106. The embedded representation of the classification token determined by pipeline 310 may be used as contextual text embedding 114. Another special token that may be incorporated by preprocessing layer is the separator token (e.g., “[SEP]”). The separator token acts as a boundary marker delineating sentences or segments within text data 106. Incorporating separator tokens ensures clear demarcation and enables pipeline 310 to distinctly interpret and process each part (e.g., sentence or segment) within text data 106. Another special token that may be incorporated is a “[PAD]” token. This token may be incorporated to ensure consistency in length of text data input to pipeline 310 such that shorter input text data is padded to match the length of the longest input text data. This length uniformity may facilitate more efficient batch processing of a batch of input text data and optimize the operational efficiency of pipeline 310. Another special token that may be incorporated during the training of pipeline 310 is a “[MASK]” token. This token may be utilized during training of pipeline 310 for masked language and modeling learning objectives by temporarily substituting for selected tokens in the training input, driving pipeline 310 to predict and recover the original tokens and thereby enhance the predictive capability and adaptation to varied contextual scenarios of pipeline 310.

The embedding layer of pipeline 310 converts tokens of text data 106 into high-dimensional embeddings. The embedding layer may determine token embeddings for tokens of text data 106 determined by the preprocessing layer. For example, each token embedding may be fetched from a pre-trained matrix where each unique token in a vocabulary of pipeline 310 corresponds to a high-dimensional embedding. The embedding layer may also determine positional embeddings that encode the positional context of each token within a text sequence of text data 106 to compensate for an incapacity of pipeline 310 to infer sequential or positional dependencies. Embedding layer may also determine a segment embedding for each token. The segment embedding may be indicative of the token's associative sentence or segment of text data 106. Segment embeddings allow pipeline 310 to simultaneously process paired sentences or segments of text data 106 and facilitate a segmented understanding of text data 106 within computations of pipeline 310. The various embeddings—token, positional, or segment—for each token may be combined by embedding layer through vector summation to yield a combined embedding for each token that reflects the semantic, positional, and optionally the segmental aspects of the token in context of text data 106. For training pipeline 310, embedding layer may employ layer normalization and dropout techniques to ensure pipeline 310's resilience and robust generalization capabilities by mitigating overfitting risks and facilitating a smoother learning trajectory. As a result of embedding layer, each token of text data 106 is associated with a high-dimensional embedding that is a synthesis of intrinsic semantic attributes, enriched with positional and possibly segmental context.

The transformer encoding layer includes a multi-head self-attention mechanism that allows each token to dynamically focus on different segments and capture various levels of dependencies within a sequence of tokens from text data 106. The multi-head self-attention mechanism may discern context relationships for each token in the sequence by attending to other tokens in the sequence. This may be accomplished, for example, by deriving query, key, and value vectors from each token's embeddings determined by the embedding layer. The query, key, and value vectors contribute uniquely to calculating attention weights. The weights may be determined, for example, by computing the dot product of the query and key vectors, following by scaling and a softmax operation, ensuring that the attention weights sum to one, and facilitating probabilistic interpretation of attention scores. The multi-head mechanism may operate by parallelizing multiple instances of self-attention, each with distinct learned weight matrices, termed “heads.” Each head may function independently of other heads and capture different facts or relationships within the sequence of tokens, thereby allowing a multi-dimensional perspective and comprehension of textual contexts and dependencies.

Transformer encoding layer encompasses a position-wise feed-forward neural network that ensures that a token's position within a sequence of tokens from text data 106 is acknowledged and leveraged during processing. The embedding determined for a token by the embedding layer that encodes position-specific information about the token may be processed by the feed-forward neural network independently of other embeddings for other tokens. Despite sharing the feed-forward neural network, each position (token) as encoded by the embedding may be processed distinctly to maintain the integrity of the positional information. The feed-forward neural network may include, for example, an initial linear transformation layer with a rectified linear unit (ReLU) activation function that provides the feed-forward neural network with the capability to discern and model complex, non-linear relationships. The initial layer may be followed by another linear transformation layer that is adjusted to output the requisite dimensionality. Through the feed-forward neural network, pipeline 310 discerns and captures intricate, position-specific interactions and dependencies. The feed-forward neural network may be proficient in learning and identifying nuanced patterns such as syntactical and semantical structures with text data 106, ensuring that each token's positional encoding is significantly influential in determining pipeline 310's interpretational dynamics.

During training, in a post-feed-forward neural network processing, token representations may undergo layer normalization and residual connection procedures. The normalization stabilizes pipeline 310's learning trajectory during training, while residual connections support continuity, ensuring that positional and contextual information from preceding layers is retained and not diluted through the feed-forward neural network's depth. Layer normalization operates by normalizing activations across features for each training example in a mini batch. In particular, the mean and variance are computed for each feature across as the training examples in the mini batch. The features are then normalized based on these values. By doing so, the scales of activations remain more consistent across different layers and training iterations, resulting in a more stable and efficient training process. A residual connection connects the input of a layer to its output by addition. A residual connection helps in mitigating vanishing gradients. By adding the output of a layer to its input, a residual connection provides a direct path for gradients to flow back during backpropagation where, without a residual connection, position and contextual information from preceding layers can become diluted or lost due to the depth and complexity of the transformations that the data undergoes.

The classification token is used in pipeline 310 as a conduit for aggregating and encapsulating the global information from the entirety of text data 106. The classification token is initially introduced as a placeholder at the beginning of a sequence of tokens of text data 106 and acquires meaning during the forward pass-through pipeline 310. During the encoding process, the classification token interacts with other tokens within the sequence through the multi-head self-attention mechanism. This interaction enables the classification token to assimilate and condense information across the entire sequence, absorbing varying levels of abstraction and relationships among tokens as it passes through each layer of pipeline 310. Due to the pipeline 301's architecture, specifically the multi-head self-attention mechanism, the classification token's embedding progressively acquires a rich, global comprehension of the entire text data 106. The classification token's final embedding emerges from the pooling layer and is taken as contextual text embedding 114. The pooling layer functions to aggregate or summarize information in final hidden states of the feed-forward neural network to yield a fixed size representation that is taken as contextual text embedding 114.

Pipeline 310 is trained to generate contextual text embeddings from input texts through masked language modeling and next segment prediction tasks. With masked language modeling, random tokens from the input are masked, and pipeline 310 learns to predict them using the surrounding context, considering both left and right contexts, yielding bidirectional representations. With the next segment prediction, pipeline 310 is trained to learn sequential coherence between segments of the input.

While contextual text embedding 114 can be determined from text data 106 using a bidirectional encoder representations from transformers (BERT)-based model or suitable variant thereof such as pipeline 310, contextual text embedding 114 can be determined from text data 106 using other models and techniques. For example, any or a combination of the following models and techniques may be used in addition to or as an alternative to a BERT-based model: a document embedding model configured to generate embeddings for larger blocks of texts, a recurrent neural network with gated recurrent units configured to process text sequences and capture contextual information within their hidden states where the hidden states from the last time step can be used as contextual text embedding 114, transformer models other than BERT such as a generative pre-trained transformer (GPT) model configured to determine embeddings from input texts using the representation from a special token or aggregated token representations or a text-to-text transfer transformer (T5) model configured to determine embeddings from input texts pursuing a text-to-text objective, a hierarchical convolutional neural network (CNN) with multiple layers of convolutions and pooling where higher layers capture increasingly abstract representations of the input text and the final layer providing a context text embedding, applying mean or max pooling over token embeddings can yield a fixed-size vector representing the entire input text, applying pooling operations hierarchically over sequences of tokens of the input text, learning attention weights to compute a weighted sum of token embeddings, models other than BERT such as XLNet or RoBERTa that output contextual text embeddings using a strategy similar to the classification token approach described above, or any other suitable model or technique.

### Example Convolutional Neural Network Pipeline

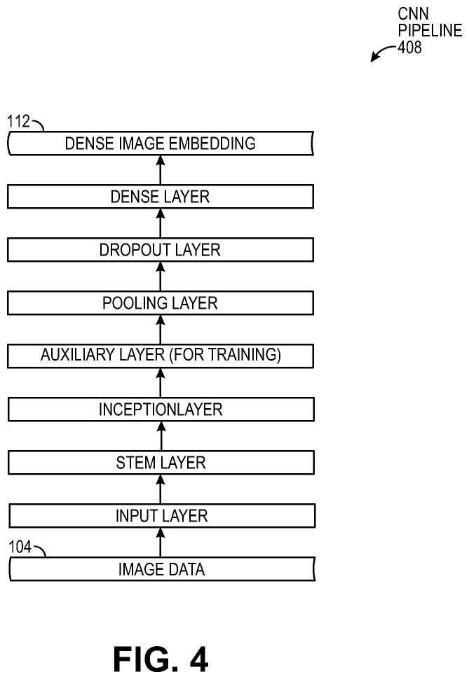

FIG. 4 illustrates an example convolutional neural network pipeline for determining dense image embedding 112 from image data 104. Convolutional neural network pipeline 408 (equivalently “CNN pipeline 408”) is trained to extract hierarchical, multi-scale features from image data 104 to determine dense image embedding 112. CNN pipeline 408 is an example of a pipeline that may be used as CNN pipeline 108 in model 100 of FIG. 1.

Returning to CNN pipeline 408 of FIG. 4, initially, the input layer accepts or downsamples or resizes image data 104 to a predetermined pixel size such as, for example, 299 by 299 pixels. The stem layer of CNN pipeline 408 is composed of convolutional and pooling layers that perform feature extraction and prime the image data for the subsequent inception layer. The inception layer carries out multiple filter operations of varying sizes (e.g., 1×1, 3×3, 5×5, etc.) concurrently. The inception layer incorporates “bottleneck” 1×1 convolutions, streamlining CNN pipeline 408 by reducing dimensionality and optimizing computational efficacy. An auxiliary layer facilitates gradient propagation during the training of CNN pipeline 408. After the inception layer, a pooling layer employs global average pooling to simplify the feature maps by averaging each one, thereby enhancing CNN pipeline's 408 robustness and computational efficiency. A dropout layer follows, mitigating overfitting by intermittently nullifying a subset of input units throughout the training process. CNN pipeline 408 concludes with a fully connected (dense) layer that flattens the output, producing dense image embedding 112 representative of image data 104's intrinsic attributes and patterns.

The stem layer performs initial feature extraction and conditioning of image data 104 for subsequent processing by CNN pipeline 408. The stem layer may encompass convolutional layers, activation functions, pooling layers, and optionally normalization layers. In the convolutional layers, the stem layer executes feature learning by applying multiple filters to discern low-level features such as textures, edges, and colors and incrementing the depth of feature maps to encapsulate more complex information. The convolutional layers increase the representational capacity of CNN pipeline 408, enabling the capturing of a multitude of characteristics and variabilities intrinsic to image data 104. Activation functions of the stem layer may be rectified linear units (ReLU) or other activation function type for allowing CNN pipeline 408 to delineate non-linear, complex mappings and intricate patterns within image data 104. The pooling layers of the stem layer facilitate downsampling, curtailing spatial dimensions to optimize computational feasibility, and enhance the robustness of CNN pipeline 408 by instilling invariance to minor input variations and distortions. The stem layer may encompass normalization layers during training of CNN pipeline 408 to standardize the scales of output features, thereby bolstering the stability and convergence of CNN pipeline 408 during the training phase.

The inception layer captures multi-level feature representations from image data 104. The inception layer may encompass parallel processing pathways that include various convolutional operations and pooling, each contributing different perspectives of the image features, followed by a concatenation step that brings together these multiple viewpoints into a unified feature map. The inception layer may utilize parallel convolutional filters of varying sizes (1×1, 3×3, 5×5, etc.), allowing CNN pipeline 408 to perceive and learn patterns across different scales and complexities, ranging from simple edges to more intricate shapes and structures. This multi-scale approach enables the capture of hierarchical representations within the image, enhancing the richness of the extracted features.

Pooling layers of the inception layer are applied in tandem with convolutional operations, introducing translation invariance and aiding in controlling overfitting. By focusing on dominant patterns and contributing to the diversity of features captured, pooling layers enrich CNN pipeline 408's understanding of input data 104.

The inception layer employs bottleneck layers, composed of 1×1 convolutions, to diminish the dimensionality of feature maps before they are subjected to larger convolutional filters. Besides improving computational efficiency, these bottleneck layers enhance the non-linearity of CNN pipeline 408, enabling more complex mappings and representations.

At the culmination of inception layer is the concatenation step where outputs from the diverse set of parallel pathways are merged along the depth dimension. This results in a comprehensive feature map that encapsulates a multi-level, multi-scale understanding of image data 104, providing a basis for subsequent layers and modules in CNN pipeline 408 for further refinement and processing.

During training, the middle of CNN pipeline 408 is configured with an auxiliary layer composed of auxiliary classifiers that ensures that the gradient vector propagates well during backpropagation and to mitigate the vanishing gradient problem common in deep neural networks. Initially, the auxiliary classifiers introduce an element of intermediate supervision within CNN pipeline 408. By employing softmax classification at various depths within CNN pipeline 408, the auxiliary classifiers facilitate the calculation of loss values at multiple stages. This approach ensures that not just the final layers, but also the intermediate layers, are adept at learning discriminative features. During backpropagation, gradients derived from these auxiliary classifiers navigate through CNN pipeline 408, mitigating the vanishing gradient issue. The auxiliary classifiers ensure that meaningful gradient information permeates the initial layers of CNN pipeline 408, fostering efficient weight updates and learning across the entirety of CNN pipeline 408. These gradients are useful in reinforcing error signals, as they combine with gradients from the final output layer, supporting the diversity and robustness of the error signals propagated backward through CNN pipeline 408. Auxiliary classifiers also serve as a regularization function, imparting a resilience against overfitting. By including multiple auxiliary classifiers within CNN pipeline 408, they deter CNN pipeline 408 from fitting excessively to the training data, improving the generalization capability when exposed to unseen data.

The pooling layer employs global average pooling for the purpose of spatial dimensionality reduction of feature maps. Global average pooling operates by calculating the average value of each feature map generated by the preceding layers in CNN pipeline 408. Global average pooling condenses each feature map into a singular value, representing the average of all its elements, effectively collapsing the spatial dimensions to a single value while retaining the depth dimension. As each feature map is transformed into a singular averaged value, the output manifests as a 1-dimensional vector, where each element signifies the averaged representation of each distinct feature map. Despite the spatial dimensionality reduction, the depth—reflecting the diversity of learned features—remains preserved, ensuring the continuation of essential feature representation.

CNN pipeline 408 is configured with a dropout layer during training to prevent overfitting. Dropout is a regularization strategy employed in neural networks to avoid overfitting, a scenario where CNN pipeline 408 overly adapts to the training data, hindering its performance on unseen data such as image data 104. Dropout operates by randomly deactivating a subset of neurons during training, governed by a predefined dropout rate. This introduces variability and inhibits CNN pipeline 408 from developing complex co-adaptations of its neurons, fostering a more generalized CNN pipeline 408. The dropout layer randomly nullifies a fraction of neurons in each training iteration. This randomness fosters diversity in the CNN pipeline 408's architecture and internal representations, deterring CNN pipeline 408 from overfitting to the noise or outliers in the training data. The tactic also discourages CNN pipeline 408 from overly relying on particular neurons, urging each neuron to be more autonomous and robust, enhancing CNN pipeline 408's capacity to generalize learned features beyond the training dataset. Dropout embodies an ensemble learning aspect. Each training iteration with dropout results in a slightly different network architecture. During inference, CNN pipeline 408 implicitly averages over these architectures, enhancing robustness and stability in CNN pipeline 408's outputs. The dropout layer is disengaged during inference, utilizing all neurons for predictions. However, an appropriate scaling, typically corresponding to the dropout rate, is applied to maintain consistency with the training phase's altered neuron activity levels. The dropout rate, dictating the fraction of neurons to deactivate, is a hyperparameter that is tuned to balance between underfitting and overfitting, steering the model towards learning generalized and robust feature representations.

The output of the dropout layer is flattened to convert the multi-dimensional output from the dropout layer into a one-dimensional vector before that vector is input to the dense layer. The dropout layer's output retains the same shape as its input because dropout involves turning off certain neurons' outputs, not altering the overall structure. To convert the output to a vector, each value from the multi-dimensional output tensor (which can be 2D, 3D, etc., depending on the dropout layer) is read and placed into a one-dimensional vector. The order of values is maintained by reading them in a row-major order (along each row from left to right and then moving down to the next row) or based on the data structure and the specific conventions of the framework being used according to the requirements of the particular implementation at hand. The resulting vector has a single dimension, where each element is a value from the dropout layer's output.

The dense layer determines an embedding or feature vector representation (e.g., dense image embedding 112) of an input image (e.g., image data 104). After the image passes through preliminary stages involving convolutional, pooling, and dropout layers, it is flattened into a vector, which becomes the input to the dense layer. In the dense layer, each neuron performs a weighted sum of all input values, accompanied by an optional bias term. These weights are mutable parameters, tuned during CNN pipeline 408's training process. Following the weighted summation, an activation function like ReLU, sigmoid, or tanh is applied, introducing non-linearity. This allows CNN pipeline 408 to grasp and emulate complex patterns and representations from the input data. Subsequently, the output of the dense layer, processed by the activation function, manifests as an embedding or feature vector (e.g., dense image embedding 112). This vector encapsulates high-level abstract features from the input image (e.g., image data 104).

Training CNN pipeline 408 for determining dense image embeddings from image data involves amassing a dataset of relevant images, followed by data augmentation techniques such as flipping and cropping to enhance model generalization. Pixel values are then normalized to standardize the dataset, ensuring network training stability and efficiency. Training CNN pipeline 408 involves using a suitable loss function, like triplet or contrastive loss, is chosen to steer the embeddings' training to ensure effective representation of the image content semantically. CNN pipeline 408 undergoes a training process involving forward propagation, backpropagation, and optimization stages, using algorithms like Adam or RMSprop for weight adjustments, promoting the minimization of the loss function. Training encompasses several epochs, utilizing mini-batch gradient descent for efficient weight updates, while continuously evaluating and fine-tuning the model based on performance against a validation dataset, adjusting hyperparameters such as learning rates and batch sizes as necessary.

While CNN pipeline 408 is used in some implementations to determine dense image embedding 112 for input data 104, alternative architectures can be used. For example, a pipeline based on any of the following models and techniques may be used: VGGNet or other like architecture characterized by its sequential layers of 3×3 convolutions and utilizing its fully connected layers to generate dense image embeddings; ResNet or other similar architecture using skip connections to mitigate the vanishing gradient problem and extracting dense embeddings from feature maps; EfficientNet or other like architecture that scales the network comprehensively, adjusting width, depth, and resolution, to ensure a balanced and efficient model; Transformer-based models like ViT (Vision Transformers) or other similar architecture that applies self-attention mechanisms to sequences of image patches and derives dense embeddings from the transformer encoder outputs; autoencoders or other like architecture that leverages their ability to encode input data into reduced-dimensionality vectors where the encoder part determines the dense embeddings; Capsule Networks or other similar architecture that enhances the convolutional networks by comprehending spatial hierarchies and relationships within object parts and that can produce detailed embeddings reflecting these intricate spatial understandings; or any other suitable model and technique.

### Example Dimensionality Reduction Sub-Networks

Both context text embedding 114 and dense image embedding 112 can have relatively high dimensionality. For example, dense image embedding 112 may have hundreds or thousands of elements (e.g., 2048). Likewise, contextual text embedding 114 may have hundreds or thousands of elements (e.g., 768 or 1024). These two embeddings along with additional feature embedding 130 are input to late fusion layer 132. These three embeddings can have varying dimensionalities. In particular, while the dimensionalities of contextual text embedding 114 and dense image embedding 112 can be in the hundreds or thousands, the dimensionality of additional feature embedding 130 can be much lower (e.g., tens of elements).

Combining feature vectors of disparate dimensionality (e.g., 12, 2048, and 1024 elements respectively) in a dense neural network can lead to several computational and representational challenges. One issue is feature dominance, where high-dimensional feature vectors (e.g., 112 and 114) may overshadow the smaller vector (e.g., 130), potentially causing underutilization of the information encapsulated in the smaller vector. This discrepancy in dimensionality can also give rise to gradient scaling issues such as vanishing or exploding gradients, hampering effective learning and representation of the input data. Learning rates also present a challenge; a universal learning rate might not be suitable due to variations in the scales and significance of different features, necessitating adaptive learning rate methodologies or individualized tuning. Regularization challenges may also manifest, where model 100 may overfit to the noise present in higher-dimensional vectors, resulting in poorer generalization and necessitating careful application of regularization techniques. Optimization complexities emerge due to variations in feature dimensions, leading to difficulties in achieving convergence during training. Additionally, the diversity in feature dimensionalities can complicate model complexity by increasing the number of parameters in subsequent layers, demanding heightened computational resources and sophisticated management of model architecture.

To counter these challenges, dense neural sub-network-1 116 and dense sub-network-2 118 reduce the dimensionality of dense image embedding 112 and contextual text embedding 114, respectively, to each be commensurate with the dimensionality of combined additional feature embedding 134.

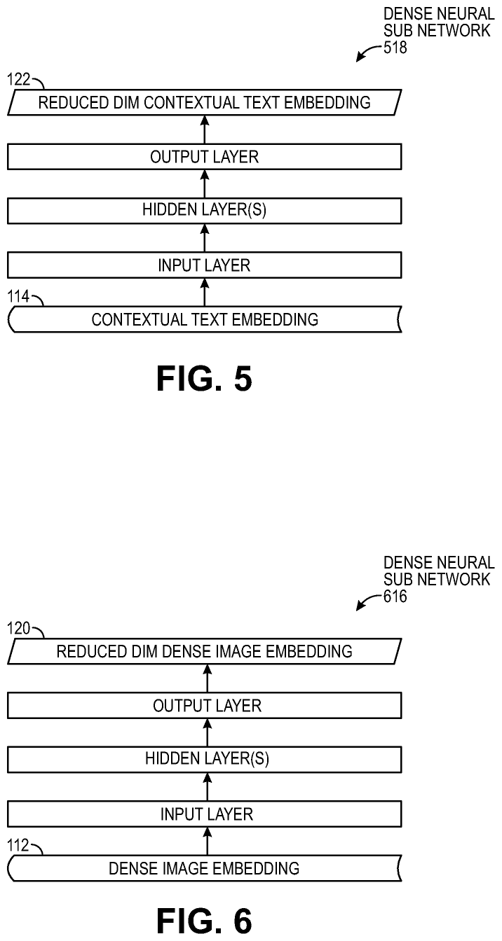

FIG. 5 illustrates an example dense neural sub-network for reducing the dimensionality of a contextual text embedding. Dense neural sub-network 518 functions to accept contextual text embedding 114 as input and output reduced dimensionality contextual text embedding 122. Dense neural sub-network 518 may be used as dense neural sub-network-2 118 in model 100 of FIG. 1, for example. Sub-network 518 includes an input layer where contextual text embedding 114 is introduced. Sub-network 518 may employ an optional normalization step during training to standardize input data, thereby facilitating stable and faster convergence during training. Sub-network 518 includes a series of hidden layers. Each hidden layer encompasses artificial neurons that perform weighted sums of inputs, add biases, and apply non-linear activation functions (e.g., ReLU) that introduce non-linearity that enable sub-network 518 to decipher and replicate intricate patterns in the input data. The output layer of sub-network 518 encompasses neurons that match the desired reduced dimensions of the embeddings.

Likewise, FIG. 6 illustrates an example dense neural sub-network for reducing the dimensionality of a dense image embedding. Dense neural sub-network 616 functions to accept dense image embedding 112 as input and output reduced dimensionality dense image embedding 120. Dense neural sub-network 616 may be used as dense neural sub-network-1 116 in model 100 of FIG. 1, for example. Sub-network 616 includes an input layer where dense image embedding 112 is introduced. Sub-network 616 may employ an optional normalization step during training to standardize input data, thereby facilitating stable and faster convergence during training. Sub-network 616 includes a series of hidden layers. Each hidden layer encompasses artificial neurons that perform weighted sums of inputs, add biases, and apply non-linear activation functions (e.g., ReLU) that introduce non-linearity that enable sub-network 616 to decipher and replicate intricate patterns in the input data. The output layer of sub-network 616 encompasses neurons that match the desired reduced dimensions of the embeddings.

Each successive hidden layer of each of sub-networks 518 and 616 may successively contain fewer neurons than its predecessor to provide a gradual diminution of data dimensions. This funnel-like structure takes the original high-dimension embedding as input and gradually narrows it down, compressing the information as passes through the sub-network. The progressive reduction of dimensions provides encapsulation of salient data features and associations, preserving the essence of the original embedding while omitting noise and less relevant information.

### Additional Features Pertaining to the Content

Returning to FIG. 1, reduced dimensionality dense image embedding 120 encapsulating features of image data 104 and reduced dimensionality contextual text embedding 122 encapsulating features of text data 106 is fused by late fusion layer 132 with additional feature embedding 130 encapsulating additional features pertaining to multimodal content 102.

Feature database 124—which may be one or more databases—stores additional features 126 pertaining to multimodal content 102. Additional features 126 stored in feature database 124 can vary depending on the type of multimodal content 102 and the intended use of numerical score 140. Possible additional features 126 pertaining to multimodal content 102 can any of all of: metadata features, user interaction features, temporal features, semantic features, network and graph features, contextual features, custom and domain-specific features, accessibility features, language and translation features, or any other suitable features.

Metadata features pertaining to multimodal content 102 may include any or all of: information about when content 102 was created or modified; details about the person or entity who created or is associated with content 102; information about where the content was created; details about the device used to create the content; or any other suitable metadata features.

User interaction features pertaining to multimodal content 102 may include any or all of: click-through rate (CRT) reflecting how often users click on content 102 or like content; social media engagement features such as a number of likes, shares, comments, or other interactions with content 102 or like content; bounce rate reflecting how quickly users navigate away from content 102 or like content after viewing content 102 or like content; user dwell time reflecting an amount of time users spend interacting with (e.g., viewing) content 102 or like content, or any other suitable user interaction features.

Temporal features pertaining to multimodal content 102 may include any or all of: seasonality reflecting a time of year or season during which content 102 or like content is most relevant; whether or the extent to which content 102 or like content reflects current topics that are popular or trending; whether content 102 or like content is related to a specific event, holiday, or occasion; or any other suitable temporal features.

Semantic features pertaining to multimodal content 102 may include any or all of: a topic or category to which content 102 or like content belongs to; keywords or tags associated with content 102 or like content; overall determined sentiment of content 102 or like content (e.g., positive, negative, neutral); or any other suitable semantic features.

Network and graph features pertaining to multimodal content 102 may include features associated with nodes or edges in a graph such as features associated with an inbound link to a node in a graph representing or corresponding to content 102, outbound link from a node in a graph representing or corresponding to content 102, or an edge in a graph.

Contextual features pertaining to multimodal content 102 may include source reputation measures reflecting the credibility and reliability of the source of content 102 or like content; webpage layout and design features reflecting how content 102 is visually presented or organized on a webpage; or any other suitable contextual features.

Custom and domain-specific features pertaining to multimodal content 102 may include any or all of: special features relevant to specific industries or domain; whether content 102 or like content adheres to industry regulations and guidelines; or any other suitable customer and domain-specific features.

Accessibility features pertaining to content 102 may include any or all of: the readability of content 102 or like content; the visual accessibility of content 102 or like content; or any other suitable accessible features.

Language and translation features pertaining to content 102 may include the language in which content 102 or like content 102 was originally created; the availability of different language versions of content 102; and or any other suitable language and translation features.

The above are just some examples of possible additional features 126 pertaining to content 102. Using a combination of features including additional features 126, features of image data 104, and features of text data 106 can enhance model 100's performance in determining numerical score 140 for multimodal content 102. The combination of features can any of all of the following types of features: numerical features (e.g., continuous features, discrete features, etc.); categorical features (e.g., nominal features, ordinal features, etc.); binary features; text features (e.g., bag-of-words, TF-IDF, etc.); temporal features (e.g., date and time, cyclical features, etc.); image features (e.g., raw pixel values; feature maps, etc.); geospatial features (e.g., latitude and longitude; geohashes, etc.); network features (e.g., graph-based features, connectivity, etc.); audio features (e.g., spectrograms; mel-frequency cepstral coefficients; etc.); sequential features (e.g., time series data; ordered lists, etc.); encoding features (e.g., one-hot encoding, label encoding, etc.); aggregated features (e.g., statistical measure such as mean, medium, or standard deviation calculated from subgroups of data); custom domain-specific features such as specialized features relevant to a particular domain or field or crafted based on expert knowledge; embedding vectors (e.g., dense vector representations for text, categories, or sequences); or any other suitable type of feature pertaining to content 102.

Model 100 includes embedding layer 128 for transforming additional features 126 into additional feature embedding 130. For example, the embedding layer may function to transform categorical additional features 126 into additional feature embedding 130. In this case, the embedding layer may encompass one or more learned weight matrices. Each row in a learned matrix may be an additional feature embedding corresponding to a unique category. Upon receiving a categorical feature of additional features 126, the embedding layer may perform a lookup process. This lookup process may involve transforming the feature into a one-hot vector and using the one-hot vector encoding of the feature to retrieve the associated embedding from a learned weight matrix. The lookup process may involve matrix multiplication between the one-hot vector and a learned weight matrix, resulting in the selection of the appropriate embedding vector for the given input feature.

Throughout the training phase, the embedding vectors in a weight matrix undergo fine-tuning and optimization, in parallel with other neural network parameters. This is achieved through methodologies such as backpropagation and gradient descent. The objective is the positioning of embedding vectors in the high-dimensional space, ensuring that semantically similar items reside closer to each other, capturing underlying categorical data patterns and relationships.

The output generated by the embedding layer is a continuous vector corresponding to the input feature, which then proceeds through layers of model 100. This continuous representation enhances model 100's ability to process and learn effectively, allowing it to discern and utilize intrinsic patterns and semantic associations within the data in the task of determining numerical score 140. This transformative capability of the embedding layer amplifies the network's proficiency in managing categorical data, ensuring that meaningful relationships and patterns within such data are effectively captured and utilized.

### Late Fusion

Model 100 includes late fusion layer 132 for combining additional feature embedding 130, reduced dimensionality dense image embedding 120, and reduced dimensional contextual text embedding 122 into fused embedding 134. Fused embedding 134 is a unified representation of content 102 that encapsulates the combined information from additional feature embedding 130, reduced dimensionality dense image embedding 120, and reduced dimensional contextual text embedding 122.

Additional feature embedding 120, reduced dimensionality dense image embedding 120, and reduced dimensional contextual text embedding 122 are fused late in model 100. That is, these embedding are not fused with each other until after dense image embedding 112 encapsulating features of image data 104 and contextual text embedding 114 encapsulating features of text data 106 have been reduced in dimensionality as reduced dimensionality dense image embedding 120 and reduced dimensionality contextual text embedding 122, respectively. Late fusion allows each modality (text, image, and additional features) to be processed by specialized neural network layers (e.g., dense neural sub-network-1 116 and dense neural sub-network-2 118) that are optimized for that type of data. Late fusion also helps preserve the unique characteristics of each modality (text, image, and additional features), ensuring that important features are not diluted or lost when combined too early. Since each modality (text, image, and additional features) are processed separately initially, sub-networks 116 and 118 can be improved, replaced, or fine-tuned independently allowing for experimentation with changes to the architecture or processing of one modality without affecting the others. Since each modality is processed to a high-level individually, fused representation 134 can be richer and more comprehensive. Late fusion also allows for fusion layer 132 that can learn to adaptively weight different modalities based on their relevance and contribution to the task. Late fusion also allows overall model 100 to exploit complex relationships and correlations between different modalities at a higher level of abstraction. In particular, combining representations at a later stage means that the fusion happens at a level where each modality's representation is already quite abstract and contextualized. Late fusion also facilitates handling discrepancies of misalignments between different modalities more gracefully, as each modality is allowed to “tell its own story” initially.

Additional feature embedding 120, reduced dimensionality dense image embedding 120, and reduced dimensional contextual text embedding 122 can be fused in various ways including by any of the following ways:

In one way, the three embeddings can be directly concatenated such that the dimensionality of fused embedding 134 is the sum of the respective dimensionalities of embeddings 130, 120, and 122. Additionally, each embedding 130, 120, and 122 can be normalized (e.g., L2 normalization) before the normalized embeddings are directly concatenated so that each embedding has an equal contribution in fused embedding 134.

In another way, if the three embeddings are each of the same dimensionality, then the three embeddings can be combined by element-wise addition or element-wise multiplication. Dimensions of the embeddings may be expanded or reduced to make the dimensionalities equal.

In another way, the three embeddings can be combined by linear weighted fusion. In this case, each of three embeddings may be assigned a different weight that is learned during training of model 100 or configured based on domain knowledge. Weighting an embedding may include multiplying each element of the embedding by the weight. The weighted three embeddings can then be combined linearly such as by element-wise addition or element-wise multiplication to yield fused embedding 134.

In another way, the three embeddings can be fused by projecting the embeddings into a common subspace using transformation matrices and fusing the embedding in the projected space. The transformation matrices may be learned during the training of model 100.

In another way, the three embeddings can be fused using a neural network such as a multi-layer perceptron that is trained to learn non-linear combinations of examples of the three types of embeddings. At inference time, the three embeddings are input to the trained neural network which outputs fused embedding 134.

In another way, two or more of the above fusion strategies may be combined. For example, the three embeddings may first be concatenated and then the concatenated embedding passed through a neural network for further fusion to yield fused embedding 134.

In another way, each of the three embeddings may be treated as a tensor and tensor fusion is performed to combine the three embeddings into a single tensor that is taken as fused embedding 134 and that captures the interactions among the multiple modes of data.

In another way, an autoencoder can be learn to a joint representation by encoding concatenated or mixed embeddings into a lower-dimensional space and then decoding it back. The trained encoder can be used at inference to generate fused embedding 134 from an input concatenation or a mixing of the three embeddings.

### Numerical Score

Fused embedding 134 is passed through dense neural sub-network-3 136. The output of dense neural sub-network-3 136 is a respective weight assigned to each dimension of fused embedding 134. Sum and sigmoid layer 138 performs a weighted sum of the values of fused embedding 134 based on the weights assigned by dense neural sub-network-3 136. A bias term may be added to the weighted sum before the weighted sum plus bias is passed through a sigmoid activation function. The sigmoid activation function maps the input to a value between 0 and 1 which is numerical score 140. Numerical score 140 can be interpreted as the likelihood of a certain class. For example, where content 102 is candidate content for presenting in a user's social media feed, a value close to 1 may indicate a high likelihood of the user clicking-through on content 102 if presented in the user's social media feed, while a value close to 0 may indicate a low likelihood of the user clicking-through on content 102 if presented in the user's social media feed.

A system may take various different actions involving content 102 depending on numerical score 140. The action taken may depend on the purpose of numerical score 140. Some actions that may be taken include any or all of the following actions:

The system may rank content 102 (e.g., advertising content) based on numerical score 140 and decide whether to display content 102 to a user (e.g., in the user's social media feed or in search results presented to the user) based on the ranking of content 102 for the purpose of personalized recommendations or otherwise ensuring that the user interacts with content that aligns with the user's preferences and interests. A higher numerical score 140 promotes visibility of content 102 to the user such as in a social media feed or search results presented to the user. One the other hand, a lower numerical score 140 may demote or exclude visibility of content 102 to the user.

The system may filter content 102 based on numerical score 140 to decide whether content 102 is irrelevant, of low quality, or potentially malicious or spam content. Content 102 may be deemed less relevant by the system based on numerical score 140 and the system may filter out content 102 to maintain the quality and relevance of the content that is displayed to a user. The system may also identify and automatically filter out content 102 based on numerical score 102 indicating that content 102 is likely spam, a scam (e.g., phishing), misinformation, harmful content, offensive, or malicious content.

The system may use numerical score 140 to ensure that a user is exposed to a diverse array of content such as in the user's social media feed and prevent echo chambers. The system may do this using dynamic thresholds applied to numerical score 140 where the system mostly uses a baseline relevance score to determine the baseline visibility of content, but the system occasionally lowers this threshold from the baseline to allow potentially more diverse content to be presented to the user even if that content is less relevant to the user than other content. The system may use category-based scoring where numerical score 140 is categorized based on the type, category, or genre of content 102. A category-specific threshold may be applied to numerical score 140 to determine whether to present content 102 to the user. The system could ensure that content from a range of categories is displayed, even if some categories have lower overall relevance scores. The system could also adjust the influence of numerical scores over time. For instance, the system could periodically change the weighting given to numerical scores to allow diverse content to be presented to the user at different times. The system may employ a balancing algorithm that considers not just numerical score 140 but also a diversity score for content 102. The algorithm can be configured to maintain a balance over time to ensure that the user is not exposed only to highly relevant content with little content diversity. User interactions and feedback with diverse content presented to users could be used to adjust model 100 over time, ensuring that model 100 learns the right balance between relevance and diversity from actual user behavior and preferences. In this case, numerical scores such as numerical score 140 generated by model 100 may encapsulate a combination of relevance and diversity for content (e.g., content 102).

The system may identify and analyze trending topics, popular content, and emerging patterns in user interests by leveraging numerical scores for content generated by model 100. For example, content with consistently high relevance scores over a short period may be identified as trending. The system can analyze image data and text data within content, combined with numerical scores determined for the content by model 100, to determine the context and subjects that are currently trending. Numerical scores determined by model 100 for content across multiple users can be analyzed by the system to identify popular content.

The system may flag content 102 for manual review based on numerical score 140. Numerical score 140 may indicate that content 102 violates community standards or user safety standards. Certain numerical scores may trigger manual review of content 102 by a content moderator if numerical score 140 for content 102 is in a “grey area” (e.g., below one threshold but above another lower threshold).

### Joint Training

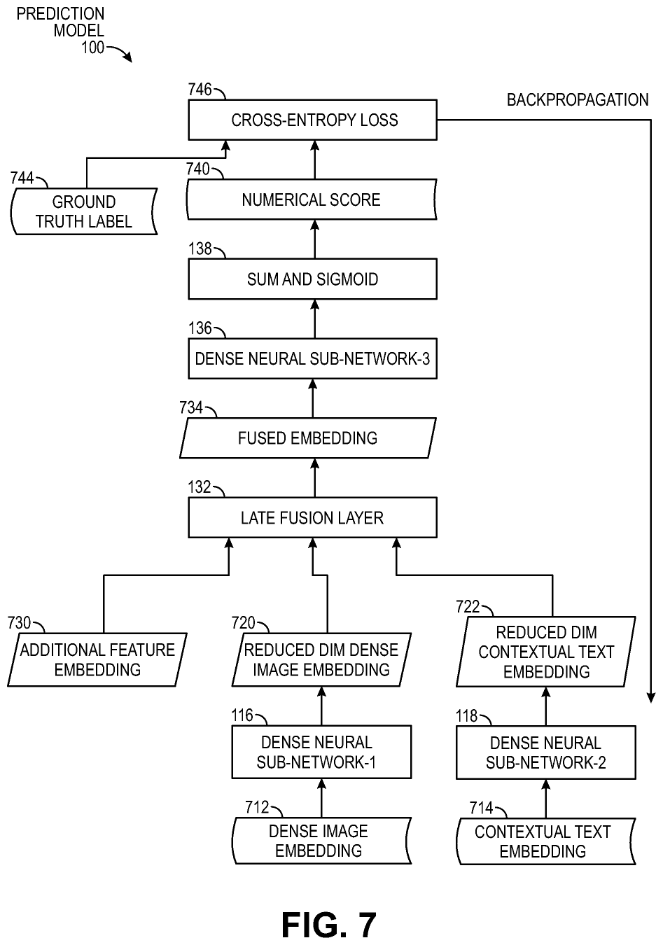

FIG. 7 illustrates an example of training of model 100 of FIG. 1. The training involves joint training of dense neural sub-networks 116, 118, and 136 such that all three sub-networks learn representations and transformations that are beneficial for the task of generating relevant numerical scores for multimodal content and ensuring that each sub-network is optimized for all overall performance. The joint training allows for the learned representations by the sub-networks to be in harmony with each other resulting in a more powerful and accurate model 100.

Model 100 is trained based on a training data set that includes many training examples of multimodal content. A training example for a multimodal content may include dense image embedding 712, contextual text embedding 714, additional feature embedding 730, and ground truth label 744 for the multimodal content. Dense image embedding 712 encapsulates image features of the multimodal content. Contextual text embedding 714 encapsulates text features of multimodal content. Additional feature embedding 730 encapsulates additional features pertaining to multimodal content. Ground truth label 744 provides a target numerical score for the multimodal content indicating the relevance of the multimodal content. The training data set encompasses many such training examples for different multimodal content.

During the forward pass of training, dense neural sub-network-1 116 takes dense image embedding 712 as input and reduces its dimensionality to yield reduced dimensionality dense image embedding 720. Dense neural sub-network-2 118 takes contextual text embedding 714 as input and reduces its dimensionality to yield reduced dimensionality contextual text embedding 722. Dense neural sub-network-3 136 takes fused embedding 734 as input and outputs to sum and sigmoid layer 138 which produces numerical score 740.

Cross-entropy loss function 746 is used to compare numerical score 740 to ground truth label 744. The gradient of loss function 745 is calculated concerning each weight (e.g., by applying the chain rule of calculus). This gradient signifies how much each weight contributed to the error between numerical score 740 and ground truth label 744. These gradients are propagated backward through model 100 from the output to the input. Each sub-network 116, 118, and 136 receives gradients that update its weights. During backpropagation, each sub-network 116, 118, and 136 is updated based on the gradient received. Since the entirety of model 100 is differentiable, gradients can flow back from the output to the input. The weights of each sub-network 116, 118, and 136 are updated simultaneously in each iteration, making the training joint. An optimizer like Adam optimizer or stochastic gradient descent (SGD) is used to update the weights based on gradients. The adjustments intend to reduce the error made by model 100's prediction in the current iteration.

Training may continue for several epochs. Each epoch may be a complete pass through the training data set. Alternatively, batch training may be used where only a subset of the training data set is processed at a time to make the optimization smoother and training more manageable. Training may employ regularization techniques such as a dropout or L2 regulation to prevent overfitting. Hyperparameters such as learning rate, number of epochs, and batch size may be tuned for optimal or improved performance. During training, input data flows through model 100, predictions are made, and a loss is calculated. Gradients are computed and propagated back through model 100 to update parameters.

### Model Variations

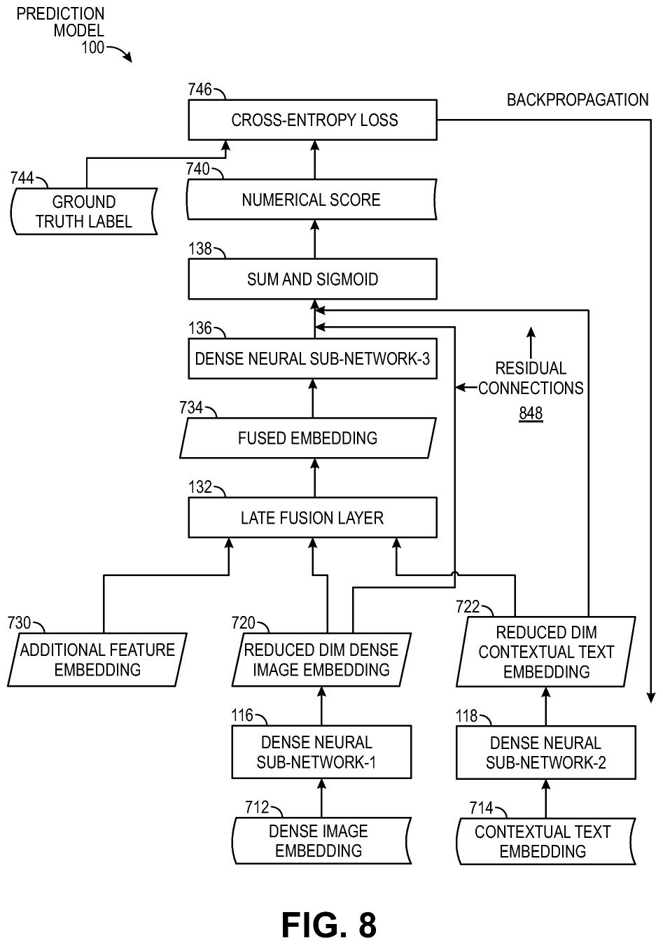

FIG. 8 illustrates a first example variation to model 100 of FIG. 1. In this variation, residual connections 848 are added during training to provide reduced dimensionality dense image embedding 720 and reduced dimensionality contextual text embedding 722 to be combined with the output of dense neural sub-network-3 136 (e.g., concatenated) before the combination is input to sum and sigmoid layer 138. Residual connections 848 may be used to mitigate the vanishing and exploding gradients in model 100.

In some embodiments, late fusion layer 132 simply concatenates additional feature embedding 130, reduced dimensionality dense image embedding 120, and reduced dimensionality contextual text embedding 122 to form fused embedding 134. This is relatively simply to implement and can operate where embeddings 130, 120, and 122 have different dimensionalities. The drawback here is that fused embedding 134 does not capture any sophisticated interaction between embeddings 130, 120, and 122.

In some embodiments, late fusion layer 132 pools (e.g., sums, averages, etc.) or computes the Hadamard product of embeddings 130, 120, and 122 to yield fused embedding 134. This is also relatively easy to implement where embeddings 130, 120, and 122 are of the same dimensionality. Dense sub-network-3 136 then operates on merged information from the embeddings 130, 120, and 122 in the form of fused embedding 134 which can be useful where interactions between text 106, image 104, and additional features 126 of content 102 carry significant information.

In some embodiments, late fusion layer 132 uses attention to allow model 100 to focus on more informative parts of the embeddings 130, 120, and 122 and weigh them accordingly by late fusion layer 132. To do this, late fusion layer 132 may determine a respective attention weight for each of the embeddings 130, 120, and 122. This can be accomplished by passing each embedding 130, 120, and 122 through a small neural network of late fusion layer 132. For example, the small neural network may encompass a one-layer neural network with a softmax activation function. During training, the small neural network can learn a set of attention weights that signify the importance of each embedding 130, 120, and 122. Each embedding 130, 120, and 122 can be multiplied by its respective attention weight. This scales each embedding 130, 120, and 122 based on their learned importance. Late fusion layer 132 may then sum or concatenate the weighted embeddings 130, 120, and 122. Since the embeddings have been scaled by their attention weights, this fusion is a form of weighted sum or concatenation, giving more importance to the more relevant parts of each embedding 130, 120, and 122.

In some embodiments, late fusion layer 132 uses multi-headed attention, allowing model 100 to focus on various parts of the input embeddings 130, 120, and 122 differently and capture a richer set of interactions. Multi-headed attention can process multiple attention-weighted versions of input in parallel (heads), which can capture various aspects and relationships with the data. Each of the embeddings 130, 120, and 122 are input to the multi-headed attention mechanism. For example, the embeddings could be treated as the Query (Q), Key (K), and Value (V) in the multi-headed attention mechanism. In multi-headed attention, multiple sets of learned weight matrices transform the original embeddings 130, 120, and 122 into different subspaces. This is done separately for each head, allowing each to learn and focus on different features and interactions. For each head, attention scores may be calculated by computing the dot product of the Query (Q) and Key (K), followed by softmax. This process determines the focus of each element in the embeddings 130, 120, and 122, emphasizing more relevant parts. The attention scores are used to take a weighted sum of the Value (V) vectors, resulting in output embeddings for each head that are attention-focused versions of the original embeddings. The output embeddings from each head are concatenated. This concatenated output contains information and interactions captured by each head, providing a comprehensive representation which may be used as fused embedding 134. An additional weight matrix can project the concatenated embeddings back to a suitable dimensionality, which may be used as fused embedding 134. This projection can mix information from the various heads, producing a unified representation. The resulting fused embedding 134 is a rich representation that has been processed by multiple attention heads, capturing various interactions and focuses across the inputs.

### Example Programmable Electronic Device

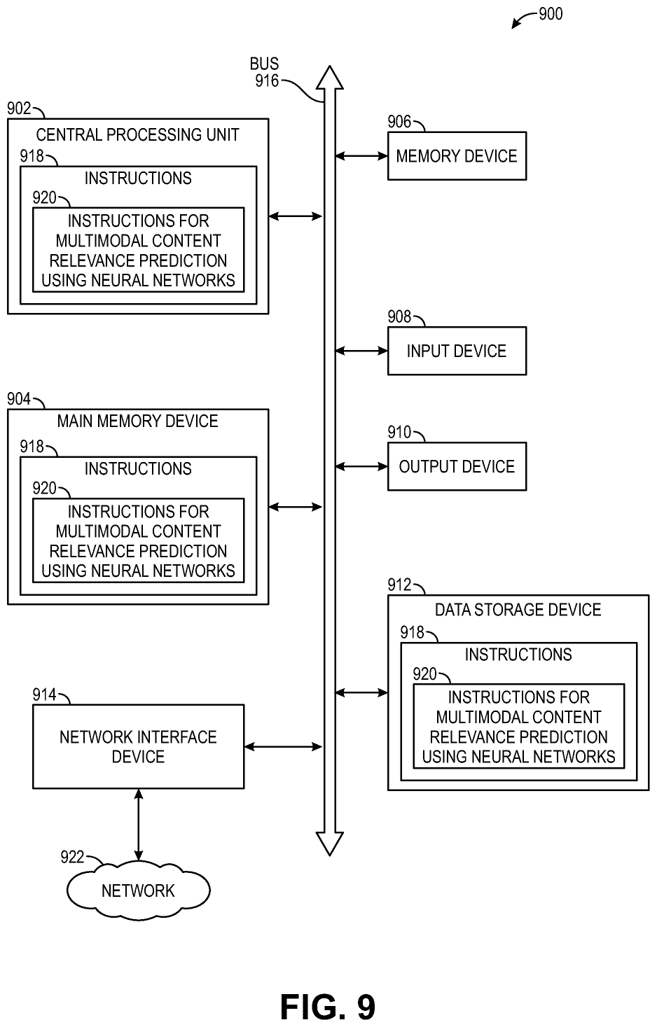

FIG. 9 illustrates an example of a programmable electronic device that processes and manipulates data to perform tasks and calculations disclosed herein for multimodal content relevance predictions using neural networks. Example programmable electronic device 900 includes electronic components encompassing hardware or hardware and software including processor 902, memory 904, auxiliary memory 906, input device 908, output device 910, mass data storage 912, and network interface 914, all connected to bus 916.

While only one of each type of component is depicted in FIG. 9 for the purpose of providing a clear example, multiple instances of any or all these electronic components may be present in device 900. For example, multiple processors may be connected to bus 916 in a particular implementation of device 900. Accordingly, unless the context clearly indicates otherwise, reference with respect to FIG. 9 to a component of device 900 in the singular such as, for example, processor 902, is not intended to exclude the plural where, in a particular instance of device 900, multiple instances of the electronic component are present. Further, some electronic components may not be present in a particular instance of device 900. For example, device 900 in a headless configuration such as, for example, when operating as a server racked in a data center, may not include, or be connected to, input device 908 or output device 910.

Processor 902 is an electronic component that processes (e.g., executes, interprets, or otherwise processes) instructions 918 including instructions 920 for multimodal content relevance predictions using neural networks. Processor 902 may perform arithmetic and logic operations dictated by instructions 918 and coordinate the activities of other electronic components of device 900 in accordance with instructions 918. Processor 902 may fetch, decode, and execute instructions 918 from memory 904. Processor 902 may include a cache used to store frequently accessed instructions 918 to speed up processing. Processor 902 may have multiple layers of cache (L1, L2, L3) with varying speeds and sizes. Processor 902 may be composed of multiple cores where each such core is a processor within processor 902. The cores may allow processor 902 to process multiple instructions 918 at once in a parallel processing manner. Processor 902 may support multi-threading where each core of processor 902 can handle multiple threads (multiple sequences of instructions) at once to further enhance parallel processing capabilities. Processor 902 may be made using silicon wafers according to a manufacturing process (e.g., 7 nm, 5 nm, or 3 nm). Processor 902 can be configured to understand and execute a set of commands referred to as an instruction set architecture (ISA) (e.g., x86, x86_64, or ARM).

Depending on the intended application, processor 902 can be any of the following types of central processing units (CPUs): a desktop processor for general computing, gaming, content creation, etc.; a server processor for data centers, enterprise-level applications, cloud services, etc.; a mobile processor for portable computing devices like laptops and tablets for enhanced battery life and thermal management; a workstation processor for intense computational tasks like 3D rendering and simulations; or any other suitable type of CPU.

While processor 902 can be a CPU, processor 902, depending on the intended application, can be any of the following types of processors: a graphics processing unit (GPU) capable of highly parallel computation allowing for processing of multiple calculations simultaneously and useful for rendering images and videos and for accelerating machine learning computation tasks; a digital signal processor (DSP) designed to process analog signals like audio and video signals into digital form and vice versa, commonly used in audio processing, telecommunications, and digital imaging; a tensor processing unit (TPU) or other specialized hardware for machine learning workloads, especially those involving tensors (multi-dimensional arrays); a field-programmable gate array (FPGA) or other reconfigurable integrated circuit that can be customized post-manufacturing for specific applications, such as cryptography, data analytics, and network processing; a neural processing unit (NPU) or other dedicated hardware designed to accelerate neural network and machine learning computations, commonly found in mobile devices and edge computing applications; an image signal processor (ISP) specialized in processing images and videos captured by cameras, adjusting parameters like exposure, white balance, and focus for enhanced image quality; an accelerated processing unit (APU) combing a CPU and a GPU on a single chip to enhance performance and efficiency, especially in consumer electronics like laptops and consoles; a vision processing unit (VPU) dedicated to accelerating machine vision tasks such as image recognition and video processing, typically used in drones, cameras, and autonomous vehicles; a microcontroller unit (MCU) or other integrated processor designed to control electronic devices, containing CPU, memory, and input/output peripherals; an embedded processor for integration into other electronic devices such as washing machines, cars, industrial machines, etc.; a system on a chip (SoC) such as those commonly used in smartphones encompassing a CPU integrated with other components like a graphics processing unit (GPU) and memory on a single chip; or any other suitable type of processor.

Memory 904 is an electronic component that stores data and instructions 918 that processor 902 processes. Memory 904 provides the space for the operating system, applications, and data in current use to be quickly reached by processor 902. For example, memory 904 may be a random-access memory (RAM) that allows data items to be read or written in substantially the same amount of time irrespective of the physical location of the data items inside memory 904.

In some instances, memory 904 is a volatile or non-volatile memory. Data stored in a volatile memory is lost when the power is turned off. Data in non-volatile memory remains intact even when the system is turned off. For example, memory 904 can be Dynamic RAM (DRAM). DRAM such as Single Data Rate RAM (SDRAM) or Double Data Rate RAM (DDRAM) is volatile memory that stores each bit of data in a separate capacitor within an integrated circuit. The capacitors of DRAM leak charge and need to be periodically refreshed to avoid information loss. Memory 904 can be Static RAM (SRAM). SRAM is volatile memory that is typically faster but more expensive than DRAM. SRAM uses multiple transistors for each memory cell but does not need to be periodically refreshed. Additionally, or alternatively, SRAM may be used for cache memory in processor 902.

Device 900 has auxiliary memory 906 other than memory 904. Examples of auxiliary memory 906 include cache memory, register memory, read-only memory (ROM), secondary storage, virtual memory, memory controller, and graphics memory. Device 900 may have multiple auxiliary memories including different types of auxiliary memories. Cache memory is found inside or very close to processor 902 and is typically faster but smaller than memory 904. Cache memory may be used to hold frequently accessed instructions 918 (encompassing any associated data) to speed up processing. Cache memory may be hierarchical ranging from Level 1 cache memory which is the smallest but fastest cache memory and is typically inside processor 902 to Level 2 and Level 3 cache memory which are progressively larger and slower cache memories that can be inside or outside processor 902. Register memory is a small but very fast storage location within processor 902 designed to hold data temporarily for ongoing operations. ROM is a non-volatile memory device that can only be read, not written to. For example, ROM can be a Programmable ROM (PROM), Erasable PROM (EPROM), or electrically erasable PROM (EEPROM). ROM may store basic input/output system (BIOS) instructions which help device 900 boot up. Secondary storage is a non-volatile memory. For example, a secondary storage can be a hard disk drive (HDD) or other magnetic disk drive device; a solid-state drive (SSD) or other NAND-based flash memory device; an optical drive like a CD-ROM drive, a DVD drive, or a Blu-ray drive; or flash memory device such as a USB drive, an SD card, or other flash storage device. Virtual memory is a portion of mass data storage 912 that the operating system uses as if it were memory 904. When memory 904 gets filled, less frequently accessed data and instructions 918 can be “swapped” out to the virtual memory. The virtual memory may be slower than memory 904, but it provides the illusion of having a larger memory 904. A memory controller manages the flow of data and instructions 918 to and from memory 904. The memory controller can be located either on the motherboard of device 900 or within processor 902. Graphics memory is used by a graphics processing unit (GPU) and is specially designed to handle the rendering of images, videos, graphics, or performing machine learning calculations. Examples of graphics memory include graphics double data rate (GDDR) such as GDDR5 and GDDR6.

Input device 908 is an electronic component that allows users to feed data and control signals into device 900. Input device 908 translates a user's action or the data from the external world into a form that device 900 can process. Examples of input device 908 include a keyboard, a pointing device (e.g., a mouse), a touchpad, a touchscreen, a microphone, a scanner, a webcam, a joystick/game controller, a graphics tablet, a digital camera, a barcode reader, a biometric device, a sensor, and a MIDI instrument.

Output device 910 is an electronic component that conveys information from device 900 to the user or to another device. The information can be in the form of text, graphics, audio, video, or other media representation. Examples of an output device 910 include a monitor or display device, a printer device, a speaker device, a headphone device, a projector device, a plotter device, a braille display device, a haptic device, a LED or LCD panel device, a sound card, and a graphics or video card.

Mass data storage 912 is an electronic component used to store data and instructions 918. Mass data storage 912 may be non-volatile memory. Examples of mass data storage 912 include a hard disk drive (HDD), a solid-state drive (SDD), an optical drive, a flash memory device, a magnetic tape drive, a floppy disk, an external drive, or a RAID array device. Mass data storage 912 could additionally or alternatively be connected to device 900 via network 922. For example, mass data storage 912 could encompass a network attached storage (NAS) device, a storage area network (SAN) device, a cloud storage device, or a centralized network filesystem device.

Network interface 914 (sometimes referred to as a network interface card, NIC, network adapter, or network interface controller) is an electronic component that connects device 900 to network 922. Network interface 914 functions to facilitate communication between device 900 and network 922. Examples of a network interface 914 include an ethernet adaptor, a wireless network adaptor, a fiber optic adapter, a token ring adaptor, a USB network adaptor, a Bluetooth adaptor, a modem, a cellular modem or adapter, a powerline adaptor, a coaxial network adaptor, an infrared (IR) adapter, an ISDN adaptor, a VPN adaptor, and a TAP/TUN adaptor.

Bus 916 is an electronic component that transfers data between other electronic components of or connected to device 900. Bus 916 serves as a shared highway of communication for data and instructions (e.g., instructions 918), providing a pathway for the exchange of information between components within device 900 or between device 900 and another device. Bus 916 connects the different parts of device 900 to each other. For example, bus 916 may encompass one or more of: a system bus, a front-side bus, a data bus, an address bus, a control bus, an expansion bus, a universal serial bus (USB), a I/O bus, a memory bus, an internal bus, an external bus, and a network bus.

Instructions 918 are computer-processable instructions that can take different forms. Instructions 918 can be in a low-level form such as binary instructions, assembly language, or machine code according to an instruction set (e.g., x86, ARM, MIPS) that processor 902 is designed to process. Instructions 918 can include individual operations that processor 902 is designed to perform such as arithmetic operations (e.g., add, subtract, multiply, divide, etc.); logical operations (e.g., AND, OR, NOT, XOR, etc.); data transfer operations including moving data from one location to another such as from memory 904 into a register of processor 902 or from a register to memory 904; control instructions such as jumps, branches, calls, and returns; comparison operations; and specialization operations such as handling interrupts, floating-point arithmetic, and vector and matrix operations. Instructions 918 can be in a higher-level form such as programming language instructions in a high-level programming language such as Python, Java, C++, etc. Instructions 918 can be in an intermediate level form in between a higher-level form and a low-level form such as bytecode or an abstract syntax tree (AST).

Instructions 918 for processing by processor 902 can be in different forms at the same or different times. For example, when stored in mass data storage 912 or memory 904, instructions 918 may be stored in a higher-level form such as Python, Java, or other high-level programing language instructions, in an intermediate-level form such as Python or Java bytecode that is compiled from the programming language instructions, or in a low-level form such as binary code or machine code. When stored in processor 902, instructions 918 may be stored in a low-level form such as binary instructions, assembly language, or machine code according to an instruction set architecture (ISA). However, instructions 918 may be stored in processor 902 in an intermediate level form or even a high-level form where processor 902 can process instructions in such form.

Instructions 918 may be processed by one or more processors of device 900 using different processing models including any or all of the following processing models depending on the intended application: sequential execution where instructions are processed one after another in a sequential manner; pipelining where pipelines are used to process multiple instruction phases concurrently; multiprocessing where different processors different instructions concurrently, sharing the workload; thread-level parallelism where multiple threads run in parallel across different processors; simultaneous multithreading or hyperthreading where a single processor processes multiple threads simultaneously, making it appear as multiple logical processors; multiple instruction issue where multiple instruction pipelines allow for the processing of several instructions during a single clock cycle; parallel data operations where a single instruction is used to perform operations on multiple data elements concurrently; clustered or distributed computing where multiple processors in a network (e.g., in the cloud) collaboratively process the instructions, distributing the workload across the network; graphics processing unit (GPU) acceleration where GPUs with their many processors allow the processing of numerous threads in parallel, suitable for tasks like graphics rendering and machine learning; asynchronous execution where processing of instructions is driven by events or interrupts, allowing the one or more processors to handle tasks asynchronously; concurrent instruction phases where multiple instruction phases (e.g., fetch, decode, execute) of different instructions are handled concurrently; parallel task processing where different processors handle different tasks or different parts of data, allowing for concurrent processing and execution; or any other suitable processing model.

Network 922 is a collection of interconnected computers, servers, and other programmable electronic devices that allow for the sharing of resources and information. Network 922 can range in size from just two connected devices to a global network (e.g., the internet) with many interconnected devices. Individual devices on network 922 are sometimes referred to as “network nodes.” Network nodes communicate with each other through mediums or channels sometimes referred to as “network communication links.” The network communication links can be wired (e.g., twisted-pair cables, coaxial cables, or fiber-optic cables) or wireless (e.g., Wi-Fi, radio waves, or satellite links). Network 922 may encompass network devices such as routers, switches, hubs, modems, and access points. Network nodes may follow a set of rules sometimes referred to “network protocols” that define how the network nodes communicate with each other. Example network protocols include data link layer protocols such as Ethernet and Wi-Fi, network layer protocols such as IP (Internet Protocol), transport layer protocols such as TCP (Transmission Control Protocol), application layer protocols such as HTTP (Hypertext transfer Protocol) and HTTPS (HTTP Secure), and routing protocols such as OSPF (Open Shortest Path First) and BGP (Border Gateway Protocol).

Network 1122 may have a particular physical or logical layout or arrangement sometimes referred to as a “network topology.” Example network topologies include bus, star, ring, and mesh. Network 922 can be different of different sizes and scopes. For example, network 922 can encompass some or all of the following categories of networks: a personal area network (PAN) that covers a small area (a few meters), like a connection between a computer and a peripheral device via Bluetooth; a local area network (LAN) that covers a limited area, such as a home, office, or campus; a metropolitan area network (MAN) that covers a larger geographical area, like a city or a large campus; a wide area network (WAN) that spans large distances, often covering regions, countries, or even globally (e.g., the internet); a virtual private network (VPN) that provides a secure, encrypted network that allows remote devices to connect to a LAN over a WAN; an enterprise private network (EPN) build for an enterprise, connecting multiple branches or locations of a company; or a storage area network (SAN) that provides specialized, high-speed block-level network access to storage using high-speed network links like Fibre Channel.

### Terminology

As used herein and in the appended claims, the term “computer-readable media” refers to one or more mediums or devices that can store or transmit information in a format that a computer system can access. Computer-readable media encompasses both storage media and transmission media. Storage media includes volatile and non-volatile memory devices such as RAM devices, ROM devices, secondary storage devices, register memory devices, memory controller devices, graphics memory devices, and the like.

As used herein and in the appended claims, the term “non-transitory computer-readable media” as used herein encompasses computer-readable media as just defined but excludes transitory, propagating signals. Data stored on non-transitory computer-readable media isn't just momentarily present and fleeting but has some degree of persistence. For example, instructions stored in a hard drive, a SSD, an optical disk, a flash drive, or other storage media are stored on non-transitory computer-readable media. Conversely, data carried by a transient electrical or electromagnetic signal or wave is not stored in non-transitory computer-readable media when so carried.

As used herein and in the appended claims, unless otherwise clear in context, the terms “comprising,” “having,” “containing,” “including,” “encompassing,” “in response to,” “based on,” and the like are intended to be open-ended in that an element or elements following such a term is not meant to be an exhaustive listing of elements or meant to be limited to only the listed element or elements.

Unless otherwise clear in context, relational terms such as “first” and “second” are used herein and in the appended claims to differentiate one thing from another without limiting those things to a particular order or relationship. For example, unless otherwise clear in context, a “first device” could be termed a “second device.” The first and second devices are both devices, but not the same device.

Unless otherwise clear in context, the indefinite articles “a” and “an” are used herein and in the appended claims to mean “one or more” or “at least one.” For example, unless otherwise clear in context, “in an embodiment” means in at least one embodiment, but not necessarily more than one embodiment. Accordingly, phrases such as “a device configured to” are intended to include one or more recited devices. Such one or more recited devices can also be collectively configured to carry out the stated recitations. For example, “a processor configured to carry out recitations A, B and C” can include a first processor configured to carry out recitation A working in conjunction with a second processor configured to carry out recitations B and C. Unless otherwise explicitly stated, the terms “set”, and “collection” should generally be interpreted to include one or more described items throughout this application. Accordingly, phrases such as “a set of devices configured to” or “a collection of devices configured to” are intended to include one or more recited devices. Such one or more recited devices can also be collectively configured to carry out the stated recitations. For example, “a set of servers configured to carry out recitations A, B and C” can include a first server configured to carry out recitation A working in conjunction with a second server configured to carry out recitations B and C.

As used herein, unless otherwise clear in context, the term “or” is open-ended and encompasses all possible combinations, except where infeasible. For example, if it is stated that a component may include A or B, then, unless infeasible or otherwise clear in context, the component may include at least A, or at least B, or at least A and B. As a second example, if it is stated that a component may include A, B, or C then, unless infeasible or otherwise clear in context, the component may include at least A, or at least B, or at least C, or at least A and B, or at least A and C, or at least B and C, or at least A and B and C.

Unless the context clearly indicates otherwise, conjunctive language in this description and in the appended claims such as the phrase “at least one of X, Y, and Z,” is to be understood to convey that an item, term, etc. can be either X, Y, or Z, or a combination thereof. Thus, such conjunctive language does not require that at least one of X, at least one of Y, and at least one of Z to each be present.

Unless the context clearly indicates otherwise, the relational term “based on” is used in this description and in the appended claims in an open-ended fashion to describe a logical (e.g., a condition precedent) or causal connection or association between two stated things where one of the things is the basis for or informs the other without requiring or foreclosing additional unstated things that affect the logical or casual connection or association between the two stated things.

Unless the context clearly indicates otherwise, the relational term “in response to” is used in this description and in the appended claims in an open-ended fashion to describe a stated action or behavior that is done as a reaction or reply to a stated stimulus without requiring or foreclosing additional unstated stimuli that affect the relationship between the stated action or behavior and the stated stimulus.

### Privacy and Bias

The techniques described herein may be implemented with privacy safeguards to protect user privacy. Furthermore, the techniques described herein may be implemented with user privacy safeguards to prevent unauthorized access to personal data and confidential data. The training of the AI models described herein is executed to benefit all users fairly, without causing or amplifying unfair bias.

According to some embodiments, the techniques for the models described herein do not make inferences or predictions about individuals unless requested to do so through an input. According to some embodiments, the models described herein do not learn from and are not trained on user data without user authorization. In instances where user data is permitted and authorized for use in AI features and tools, it is done in compliance with a user's visibility settings, privacy choices, user agreement and descriptions, and the applicable law. According to the techniques described herein, users may have full control over the visibility of their content and who sees their content, as is controlled via the visibility settings. According to the techniques described herein, users may have full control over the level of their personal data that is shared and distributed between different AI platforms that provide different functionalities.

According to the techniques described herein, users may have full control over the level of access to their personal data that is shared with other parties. According to the techniques described herein, personal data provided by users may be processed to determine prompts when using a generative AI feature at the request of the user, but not to train generative AI models. In some embodiments, users may provide feedback while using the techniques described herein, which may be used to improve or modify the platform and products. In some embodiments, any personal data associated with a user, such as personal information provided by the user to the platform, may be deleted from storage upon user request. In some embodiments, personal information associated with a user may be permanently deleted from storage when a user deletes their account from the platform.

According to the techniques described herein, personal data may be removed from any training dataset that is used to train AI models. The techniques described herein may utilize tools for anonymizing member and customer data. For example, user's personal data may be redacted and minimized in training datasets for training AI models through delexicalisation tools and other privacy enhancing tools for safeguarding user data. The techniques described herein may minimize use of any personal data in training AI models, including removing and replacing personal data. According to the techniques described herein, notices may be communicated to users to inform how their data is being used and users are provided controls to opt-out from their data being used for training AI models.

According to some embodiments, tools are used with the techniques described herein to identify and mitigate risks associated with AI in all products and AI systems. In some embodiments, notices may be provided to users when AI tools are being used to provide features.

### CONCLUSION

In the foregoing specification, embodiments of the disclosure have been described with reference to specific example embodiments thereof. It will be evident that various modifications can be made thereto without departing from the broader spirit and scope of embodiments of the disclosure as set forth in the following claims. The specification and drawings are, accordingly, to be regarded in an illustrative sense rather than a restrictive sense.

What is claimed is:

1. A method comprising:
determining a reduced dimensionality dense image embedding from a dense image embedding using a first pretrained dense neural sub-network, the dense image embedding encapsulating features of a digital image associated with a multimodal content;
determining a reduced dimensionality contextual text embedding from a contextual text embedding using a second pretrained dense neural sub-network, the contextual text embedding encapsulating features of a text associated with the multimodal content;
determining a numerical score of a multimodal content using a third dense neural sub-network, the reduced dimensionality dense image embedding, and the reduced dimensionality contextual text embedding; and
ranking the multimodal content based on the numerical score.

2. The method of claim 1, wherein the dense image embedding is generated using a pretrained convolutional neural network; wherein the pretrained convolutional neural network comprises convolutional layers and pooling layers; and wherein the pretrained convolutional neural network generates the dense image embedding based on:
extracting hierarchical features from the digital image by applying convolutional operations in parallel to capture the hierarchical features at different scales;
passing feature maps through fully connected layers; and
obtaining the dense mage embedding as output of the fully connected layers.

3. The method of claim 1, wherein the contextual text embedding is generated using a pretrained transformer neural network; wherein the pretrained transformer neural network comprises transformer layers to capture bidirectional contexts; and wherein the pretrained transformer neural network generated the contextual text embedding based on:
tokenizing the text into tokens;
adding special tokens that assist in classification and in separating segments of the text;
passing each of the tokens through the transformer layers; wherein the transformer layers comprise an attention mechanism for contextually informing each token based on other tokens of the text;
obtaining token embeddings for the tokens as output of the transformer layers; and
pooling the token embeddings to yield the contextual text embedding.

4. The method of claim 1, wherein the first pretrained dense neural sub-network comprises fully connected layers that successively reduce a dimensionality of an input.

5. The method of claim 1, wherein the second pretrained dense neural sub-network comprises fully connected layers that successively reduce a dimensionality of an input.

6. The method of claim 1, further comprising:
fusing the reduced dimensionality dense image embedding, the reduced dimensionality contextual text embedding; and
determined the numerical score based on the third dense neural sub-network and the fused embedding.

7. The method of claim 1, further comprising:
causing the multimodal content to be presented to a social media feed based on a ranking of the multimodal content.

8. The method of claim 1, wherein the reduced dimensionality dense image embedding and the reduced dimensionality contextual text embedding.

9. A system comprising:
at least one processor;
memory storing instructions to be executed by the at least one processor, the instructions for:
in a machine learning pipeline stored in the memory and executed by the at least one processor:
determining, by a first pretrained dense neural sub-network of the machine learning pipeline, a reduced dimensionality dense image embedding from a dense image embedding, the dense image embedding encapsulating features of a digital image associated with a multimodal content;
determining, by a second pretrained dense neural sub-network, a reduced dimensionality contextual text embedding from a contextual text embedding, the contextual text embedding encapsulating features of a text associated with the multimodal content;
fusing the reduced dimensionality dense image embedding and the reduced dimensionality contextual text embedding to yield a fused embedding;
determining a numerical score for the multimodal content using a third dense neural sub-network of the machine learning pipeline and the fused embedding; and
ranking the multimodal content based on the numerical score.

10. The system of claim 9, further comprising instructions for:
determining, by a pretrained convolutional neural network pipeline, the dense image embedding from the digital image.

11. The system of claim 9, further comprising instructions for:
determining, by a pretrained transformer neural network pipeline, the contextual text embedding from the text.

12. The system of claim 9, wherein the first pretrained dense neural sub-network comprises fully connected layers that successively reduce a dimensionality of an input.

13. The system of claim 9, wherein the second pretrained dense neural sub-network comprises fully connected layers that successively reduce a dimensionality of an input.

14. The system of claim 9, wherein the action taken comprises presenting the content in a social media feed of a user.

15. The system of claim 9, wherein the reduced dimensionality dense image embedding, the reduced dimensionality contextual text embedding, and the additional feature embedding each have a same dimensionality.

16. A non-transitory computer-readable medium storing instructions which, when executed by at least one programmable electronic device, cause the at least one programmable electronic device to perform operations comprising:
determining a reduced dimensionality dense image embedding from a dense image embedding using a first pretrained dense neural sub-network, the dense image embedding encapsulating features of a digital image associated with a multimodal content;
determining a reduced dimensionality contextual text embedding from a contextual text embedding using a second pretrained dense neural sub-network, the contextual text embedding encapsulating features of a text associated with the multimodal content;
determining a numerical score of a multimodal content using a third dense neural sub-network, the reduced dimensionality dense image embedding and the reduced dimensionality contextual text embedding; and
ranking the multimodal content based on the numerical score.

17. The non-transitory computer-readable medium of claim 16, wherein the dense image embedding is generated using a pretrained convolutional neural network; wherein the pretrained convolutional neural network comprises convolutional layers and pooling layers; and wherein the operations further comprise:
extracting hierarchical features from the digital image by applying convolutional operations in parallel to capture the hierarchical features at different scales;
passing feature maps through fully connected layers; and
obtaining the dense mage embedding as output of the fully connected layers.

18. The non-transitory computer-readable medium of claim 16, wherein the contextual text embedding is generated using a pretrained transformer neural network; wherein the pretrained transformer neural network comprises transformer layers to capture bidirectional contexts; and wherein the operations further comprise:
tokenizing the text into tokens;
adding special tokens that assist in classification and in separating segments of the text;
passing each of the tokens through the transformer layers; wherein the transformer layers comprise an attention mechanism for contextually informing each token based on other tokens of the text;
obtaining token embeddings for the tokens as output of the transformer layers; and
pooling the token embeddings to yield the contextual text embedding.

19. The non-transitory computer-readable medium of claim 16, wherein the first pretrained dense neural sub-network comprises fully connected layers that successively reduce a dimensionality of an input.

20. The non-transitory computer-readable medium of claim 16, wherein the second pretrained dense neural sub-network comprises fully connected layers that successively reduce a dimensionality of an input.
